(19) United States
(12) Patent Application Publication
(10) Pub. No.: US 2005/0163462 A1
(43) Pub. Date: Jul. 28, 2005

(54) Motion picture asset archive having reduced physical volume and method

(76) Inventors: Buell Andrew Pratt, Sammamish, WA (US); William Gibbens Redmann, Glendale, CA (US)

Correspondence Address: William G. Redmann, 1202 Princeton Dr., Glendale, CA, 91205, US

(21) Appl. No.: 10/766,700

(22) Filed: Jan. 28, 2004

(51) Int. Cl. H04N 9/74; H04N 11/00

(52) U.S. Cl. 386/4; 386/1

(57) ABSTRACT

An archive of motion picture assets having reduced physical volume and method of manufacture are disclosed. All B-negative, trims and outs, sound rolls, mag, dailies, work prints, scripts, and reports are manually consolidated and indexed by a computer database retain accessibility. The consolidated assets are digitized and made available in thumbnail versions to users remote from the archive, thereby increasing the availability, usability, security, and value of the consolidated assets.

### FIELD OF THE INVENTION

The present invention relates generally to a method for processing the media elements of a motion picture. More particularly, it relates to a method for reducing the physical volume required to store the media elements produced in the making of a motion picture, including the kept takes trims and outs, B-negative, audio tapes, work print, script, associated notes, and the like, while preserving information about the original relationships, synchronization, and physical location of related elements.

### CROSS REFERENCE TO RELATED APPLICATIONS

This application is related to a second application filed on the same day and having the same first named inventor, Buell Andrew Pratt, entitled “Method and Apparatus for Improved Access to a Compacted Motion Picture Asset Archive.”

### STATEMENT REGARDING FEDERALLY SPONSORED RESEARCH OR DEVELOPMENT

Not Applicable

### REFERENCE TO COMPUTER PROGRAM LISTING APPENDICES

Not Applicable

### BACKGROUND OF THE INVENTION

When a motion picture is made, there is a tremendous amount of film shot, many times more than appears in the final version. An excellent “shooting ratio” might be ten-to-one, while twenty-five-to-one is average, and even sixty-to-one is not rare. A typical 90-minute running feature film normally fits on about five reels of film. Each reel holds about 2000′ of film. That film will typically have originated as about 250 reels of raw film. However, after the editing process is complete, the pieces are typically stored in 300-700 cans or boxes of film.

The extra film footage occurs for two reasons. First, a given scene is usually shot multiple times (each time is called a “take”) until the actors get it just right and the director is satisfied. Second, the camera is commonly moved to different viewpoints and the actors act out the scene again. Each such viewpoint is called a “set-up.” Further, a given scene might be shot by multiple cameras running simultaneously and covering different parts of the action. Obviously, not all of that extra film will have a place in the edited feature.

However, this gigantic surplus of material is rarely discarded.

Common today are “Director's Cuts” and the “Bonus Features” prominently advertised for DVDs. For decades, alternate edits have been assembled for film versions to be exhibited on airlines, broadcast television, and for foreign distribution. For any of these, the wealth of excess coverage provides flexibility.

Since the beginning of film, production teams have attempted to minimize costs by minimizing the number of days expensive stars, large casts, or elaborate sets were required. A piece of film represents the distillation of that investment. As such, even those bits that are doomed to lie “on the cutting room floor” have represented inestimable value. That studios maintain vast archives of such excess materials for many decades after a film is produced is direct evidence of this. Millions of dollars in warehousing costs are expended each month to store such outtakes.

An ironic effect is that, while these assets are so valuable, the manner of their storage leaves them largely inaccessible. The cost of retrieving a single snippet of film from deep storage is significant, even if one were to know where it lay! For the most part, the location and nature of stored outtakes is rarely known with more accuracy than the movie title and warehouse location. Retrieval of a single element essentially requires shipping an entire collection of forklift palettes loaded with film cans. You might only want a particular scene, but often you must retrieve the entire movie. This represents an expense that makes no economic sense—with effective inaccessibility being the result.

Warehouse temperature and humidity must be controlled. The assets must be safe from fire and natural disasters. In many cases, warehouses with such characteristics and scale are not economical in Hollywood for long term storage. Some studios have reverted to storing these assets in converted salt and limestone mines in the mid-west or eastern United States, adding the burden of cross-country shipping to the accessibility issue.

Origin and Relationship of Motion Picture Elements

In the course of creating a motion picture, a tremendous amount of collateral information is created, in addition to film.

Consider the script. Usually around 150 pages, the script represents a prose description of the scenes planned for a movie.

Once the production's cast and crew assemble on the set and shooting begins, the script supervisor follows the activities and makes notes about each set-up and take.

Generally, though individual production teams may vary the terminology or designations a bit, it works like this:

When production is about to begin, the script is “locked”. At this time, each scene in the script is given a number, starting at one. From then on, if a scene is deleted, the number is still preserved, though marked in the script as “DELETED.” If a scene is added, it is given a prefix, typically a letter, to indicate where it belongs in the sequence. Thus, after the lock, if a scene were to be added between Scenes 12 and 13, it would be called Scene A12. One added after that would be B12.

The “set” is the place where the film is shot, whether outside, or on a stage.

When a scene is to be shot, the assistant director organizes the cast and crew (“Places! Quiet on the set!”). Everyone on the set quiets down. The director commands the camera and tape recorder to start (“Roll 'em!”). The sound technician makes an audible note on tape, e.g. “Scene 12, Take 1”. The camera operator announces that his camera is rolling and synchronized with the sound technician's machine (“Speed.”). Each camera is equipped with a “slate” or “clapper,” on which the camera assistant has written “Scene 12, Take 1” along with his camera's designation. Often, other important information such as show title, director, camera operator, camera speed, filters and lenses used, etc., is inscribed on the slate. The camera assistant claps the slate, so that the closing bars of the clapper mechanism are both seen by the camera and heard by the microphone. Later, the writing on the slate allows the film to be visually identified, as does the audible note on the tape. The two recordings of the clap (one audio, one visual) will be used to synchronize sound with picture.

Now that the recording equipment is ready, the director commands the actors to begin (“Action!”). The actors begin the scene, and continue through it until the director ends it (“Cut!”).

A given scene is usually shot many times. The shooting of a scene will typically begin with a master shot which encompasses most, if not all, of the scene's action. Each time the camera rolls and the cast and crew perform the scene, the take count increments. The first time the cast runs through scene 12 is take 1. The next time is take 2, and so on until the director is satisfied. The camera is then usually moved or adjusted for other takes. Long shots, medium shots, 2-shots, over-the-shoulder shots, profiles, close-ups, reaction shots, etc. within a scene are commonly denoted by a set-up suffix to the scene number. After the master shot, a new camera set-up would be slated as scene 12A, 12B, etc. Commonly, the takes count starts over with each set-up.

For complex or expensive scenes, especially scenes that involve the destruction of the set, a production company will make use of multiple cameras. Each camera provides a different vantage. Each camera is uniquely identified (e.g. Camera A, B, etc.) and each roll of film loaded into a camera takes this identity, plus a sequence number (e.g. Camera Roll A-15).

In order to save money and time, not all takes are printed for viewing the next day. If the take contained some error in dialog, an actor trips or misses a cue, or the director is otherwise unsatisfied with the performance, another take is made. However, if the director considers that even part of the take is usable, he'll call for that take to be screened the following morning (“Print it!”).

Each take, and each of the director's decisions is recorded by the script supervisor, the assistant camera operator, and the sound technician by notes in the script notes, camera reports, and sound reports, respectively. Each take is identified as good (a “circled take”) or bad (a “non-circled take”).

The script-supervisor will also mark up a script showing precisely which lines of the scene are being performed. As an example, if a shot is a close-up of one character having a conversation with another character off-screen, the script supervisor will note who is on camera and who is off. Notes are made for each take. Why a take was good, or why a take was faulty. If the director says “Print it!” the script supervisor, assistant camera operator, and the sound technician all note that by circling the take number.

Overnight, the film rolls are developed. This film is first generation, camera negative. The director's “circle takes,” as noted by the assistant camera operator, are separated from the rest, and spliced together, and a positive print, (known as a workprint), made from this negative. The negative that is spliced together for printing is termed “A-negative,” while the remainder is the “B-negative.”

Another overnight process transfers the audio to a format, historically a magnetic stripe on a film stock (known as mag stock) that can be handled like, and synchronized with, the picture film.

Early in the morning, an assistant editor assembles and ‘syncs-up’ the circle takes from the workprint with the audio on mag stock, using the clap to ensure that the picture and sound films have the correct alignment. The film and audio together comprise the “dailies roll,” which is usually available for viewing early in the day. These are sometimes known as “rushes,” for obvious reasons. Until the dailies have been reviewed, it is perilous to take down the sets—in case something has to be re-shot. For instance, if a camera had suffered a mechanical failure that produced an overexposed or blurred image throughout a day's work, none of its film would be usable. If that film is critical, a re-shoot will probably be necessary.

Because of the relationship between A and B-negative, only rarely is B-negative printed, synchronized with sound, and then viewed.

If there is a re-shoot, the slate indicates this, as in scene R12A (a re-shoot of scene 12, set-up A), etc.

In modern filmmaking, the dailies, with sound, are transferred to video by a machine called a telecine. Editors edit the film in video or on a computer using a digital system. Historically, the editing was performed using the dailies prints themselves. When the editor is finished with the digital edit, an assistant editor uses an edit decision list to assemble the workprint and mag. This is known as a rough cut. After screening this with the various decision makers (director, producer, actors, studio heads, test audiences), revisions are made, known as fine cuts.

At some point, all the editing decisions are compiled in a single list, and a negative cutter is given the responsibility of cutting up the original A-negative rolls according to the list, and assembling the movie out of first generation negative.

The leftover A-negative is saved, typically as thousands of little rolls of film in labeled boxes. Every slate is there, every shout of “Action!” The end of every take is there, usually to the moment when the director was shouting “Cut!” These heads and tails of takes are grouped together with the bits and pieces removed from takes that were chosen for the final film (collectively, the “trims”). Also present are entire unused takes (the “outs”). Occasionally, there is no A-negative remnant, as when an entire take is used, a take is sent out for further processing as a special effects element, or (rarely) the take has been misplaced or destroyed. The trims for a take are rolled up carefully. The negative handler knows that if someone's mind changes that these pieces will be required, and that he will be required to know where they are, usually in a hurry. Each little roll is marked with scene & take. Related takes are boxed together, and the boxes marked.

Similar care has been accorded the B-negative. In a pinch, the B-negative might be called for.

As a result, at the conclusion of work on a film, editors find themselves with a film, usually five to seven reels long, that started as perhaps twenty to thirty times that many rolls of film, and that now occupies the boxes filling the space of eighty to one hundred times that many reels. All of this material is organized and is usually delivered to the film distributor for potential use in editing future versions of the film (e.g. for television, DVDs, “Director's Cuts,” or theatrical re-releases).

Inventory Control Systems

For scores of years, these boxes have lain in warehouses. Boxes numbering several hundred per movie, belonging to studios producing scores of pictures per year, every year, each box containing precious camera negative, sound recordings, and paperwork. The cost of storage for a single studio is many millions of dollars per year.

One of the primary functions of any generic storage warehouse is to track the location of the items stored in it. While this can be done using file cabinets and paper records, most present-day warehouses make use of computer databases to locate items, and to track their arrival and departure.

The storage of film media assets is handled similarly. The boxes of a film's media assets (exclusive of the finished picture negative and a few other release-related elements) are warehoused. Film boxes are packaged in groups of about five, those packages are stacked on palettes, and those palettes are shipped to a warehouse where they may not be touched for months, years, or decades. When any of the original assets is called for, it is common practice for the entire collection to be moved.

Often enough, pieces of the collection cannot be found or identified in a timely manner. Palettes may become separated from one another, or the packages on them separated, or opened. Film boxes can become misplaced—sometimes placed with another film's assets in error; sometimes moved to a separate warehouse so that film assets are not kept together. In such a circumstance, it is possible that not all assets to a film will be available at the same time. Certain assets may experience a great delay in being found or identified. In some cases, due to a limited budget, the search for missing assets is called off without the asset being found.

Though modern warehouses can employ bar-coded tags, making it easier to identify and track boxes, this does not represent the majority of storage practice throughout the history of filmmaking. Even with modern storage practices, mis-identification, duplication, and loss still occurs.

Non-Linear and Digital Editing Systems

Systems exist today for efficient handling and processing of the many elements that go into a motion picture.

Historically, the editing process for film and videotape required that the many pieces of shots selected by an editor be physically sequenced to form a single, continuous (hence, “linear”), asset. In film, the editor would cut and splice pieces from a work print, rather than cutting the original camera negative, until all the editing decisions were settled and approved. For television, videotape was initially cut and spliced, as if it were film. Later, individual clips from video were copied one after another onto a single destination tape.

In the early-1970s, a great change began: Video editing first employed computer-assisted technology. U.S. Pat. No. 3,721,757 by Ettlinger and U.S. Pat. No. 3,740,463 by Youngstrom et al. teach that an array of computer driven videotape players can accept instructions from the editor and in real-time play the appropriate portions of a collection of videotapes in the sequence specified by the editor.

In the mid-1980s, in U.S. Pat. No. 4,746,994, Ettlinger advanced the technology for use in film. The videotapes used were now traditional film dailies rolls that were transferred to videotape. Here, Ettlinger's computer system provides for an association between a line of dialog in the script and the location of various records of various performances of that line on the videotapes.

The use of magnetic disk based video editing is taught by Crane et al., U.S. Pat. No. 6,201,924. Here, videotapes and videodisk players under computer control have been replaced by a computer that digitizes audio and video material and stores the resulting data on a hard drive.

Improvements to the user interface for non-linear editing systems include U.S. Pat. No. 5,206,929 by Langford et al., wherein an improved method for selecting edit transitions is presented; and Hatta, whose U.S. Pat. No. 6,650,826 teaches an improved graphical user interface for selecting, viewing, and editing audio and video clips.

Peters et al., in U.S. Pat. No. 6,618,547, provides information on how to maintain compatibility between 30 frame-per-second (FPS) video editing and 24 FPS film.

In U.S. Pat. Nos. 6,061,758 and 6,636,869, Reber et al. have shown how an edited program, comprised of a sequence of clips, can maintain independence from specific asset files by relating a time range in one asset file to a time range in other asset files derived from the same physical asset. By doing so, it is not necessary that data files be persistent. However, it is necessary that clips being edited are referenced to time ranges in media files. The drawback to this technique is that files of the asset may not exist at the time clips are to be specified and plausibly, such asset files may never exist.

Ettlinger's “non-linear editing” (so called because the finished program does not exist on a single strip of videotape, but is the result of the computer skipping back and forth among many separate dailies transfers) allows an editor to produce an edited film without cutting any film until the editing is complete.

Many products today embody these, and other improvements, and provide an array of tools for creating motion pictures. Products, such as Avid Film Composer by Avid Technology Inc. of Tewksbury, Mass. and Lightworks, by Lightworks NLE, Ltd. Of London, England are representative of these.

There is a tremendous advantage to these video- and computer-based editing systems, and their improvements. Specifically, the precious, original camera negative is subjected to cutting only after editing is complete and a list of the editor's decisions have been made and compiled by the computer system. Thus, the handling of the negative is minimized, and in most cases the editing process is more efficient.

Identifying Film

Key to the success of the editing process, especially non-linear editing, is the ability to carry all of the edit decisions resulting in final edited digital version of the film to the camera negative.

Since 1916, motion picture negative stock has included “edge codes” (latent identifying marks placed outside the image bearing area of the film) that become visible when the film is processed. Originally used to identify the manufacturer and film type, they grew to include a running number that appeared every 16 frames or 12 inches of 35 mm negative. These numbers are able to be printed through to the workprint, and are considered “key” to maintaining a relationship between the edited workprint and the negative, hence the term “key numbers.” During the early nineties, key numbers were reconfigured to consist of 3 groups of 4 digits which include film type, a batch number, a running footage count, and a bar code that carries the same information. There is also now a secondary information group between each of the primary “key numbers”. Thus, every six inches or eight frames, a frame of film is uniquely identified. This makes it possible to trace the history of a film fragment that is only a fraction of a second long, and make frame accurate edits.

A factory-fresh roll of film acquired by a studio is either 400 feet or 1000 feet long. These rolls are used in the camera to “shoot” scenes. As a scene is completed the exposed part of the roll is removed from the camera, and placed in a sealed can. Each of those smaller rolls bear the original roll's batch number and unique footage counts in their key numbers.

Each time a camera is unloaded, one of these smaller rolls gains an additional identification: a camera roll number. Unique (barring human error) in each production, the camera roll number usually includes a camera designation. The camera designation aids in the identification of shots, and can also assist in tracking down the source of film damage (e.g. scratches, over exposures, blur, fogging, etc.) caused by the mechanical failure of a camera—or exonerate the cameras, if the failure is seen to affect film from multiple cameras.

Since the 1990s, bar-coded versions of the key number (such as KEYKODE™ by the Eastman Kodak Company of Rochester, N.Y.) have provided a machine-readable copy of the key number.

Editor's tools such as the DigiSync Film Barcode Reader, now manufactured by The Filmlab Group of Stokenchurch, England allows key numbers to be read with frame accuracy, directly from pieces of film (whether from the original camera negative or a work print copy). Telecine machines, devices which copy motion picture film to video, can incorporate the Digisync Film Barcode Reader, or similar readers, and automatically embed the key number information into the video record for later use by an editing system.

Even without machine readable key numbers, a technician can visually read and make note of the key numbers at critical locations, such as the beginning and end of a roll, or at a splice.

Ultimately, the final editing of the film negative is by reference to key numbers. Each cut and splice is defined by the key number of the last frame of previous clip, and the key number of the first frame of the next clip.

Excalibur, a software product also produced by The Filmlab Group, is an example of a program that allows the recording of key numbers (whether automatically or manually read) and provides an associated with footage counts within an assembled roll. Thus, as an editor performs the traditional assembly of a work print or a dailies roll, the length of each segment, the location of each splice, and the precise identity of the original negative can be recorded. This allows an exact reference back to the original camera negative.

During production, as each take is made, manual logs are kept of what scenes, set-ups, and takes are made on which camera rolls. Slates further aid in the identification within the roll.

Video Libraries and Media Servers

Movies-on-demand have been demonstrated over cable television networks. Clanton, III et al., in U.S. Pat. No. 5,745,710, teaches graphical user interface to facilitate such an interaction, wherein a subscriber can select any motion picture from the online catalog. Once selected, the motion picture begins to play over the subscriber's cable TV.

Purchase of multimedia products is taught by Bernard, et al., in U.S. Pat. No. 5,918,213. Bernard's system allows a purchaser to sample a multimedia product, and optionally purchase it and received online delivery.

However, long term media archives are limited in two ways.

First, media archives are limited in their storage size. To date, even the largest present-day video-on-demand services offer only a two to three hundred titles.

A key inhibitor is the cost for storage of large numbers of full-length feature films that must also be accessible to large numbers of users at a moment's notice. With a typical Hollywood shooting ratio of 25:1, such a system would only store the total shot footage of about 10 films—far less than the yearly output from a first-tier studio.

The second limitation of media archives and media libraries, is that they are indexed and accessible by only to the resolution of a title. If you are interested in a specific scene from a particular movie, you must first access the movie. In a film library, the archivist may provide you with a film roll, or a videotape. The subsequent search for a specific scene is a manual search. Even modern DVDs only provide their “scene selection” feature to the resolution of about forty points in the movie—not the scene designations provided by the original script.

Though a non-linear editing system provides significantly finer access to film elements (for the duration of the editing process), but does not track the physical location of film assets.

### SUMMARY OF NEEDS UNSATISFIED BY PRIOR ART

At best, present motion picture inventory control systems merely track the location and number of boxes of film. The boxes themselves are generally marked with their contents, these markings typically left by editors while finishing up a picture. There is a need for a finer degree of access to individual pieces of film.

Access to the assets of a particular film is unreliable. The large number of boxes containing a motion picture's original assets will fill many warehouse pallets. Even if intact after many years, the individual pallets may have become separated. Requested assets may be retrieved over an extended period, and in an arbitrary order.

Thus, there is a need for a manner of processing film assets as they are retrieved from warehouse storage, such that the incompleteness and out-of-order arrival of assets (e.g. half of the motion picture assets may be found immediately, but the appropriate script and sound assets may not be among them) does not adversely affect the processing.

The resulting relative unavailability of a specific piece of film that would be suitable to a particular need, effectively renders the entirety of the assets dead and valueless, except to the most well-funded motion picture reissue projects. There is a need for these assets to accessed easily and economically.

Further, these dead assets are organized and packaged in a manner suitable for a motion picture that is being actively edited. Space is not at a premium—during a movie's production, time and money are the scarce commodities. This organization is not suitable for material subsequently stored for decades. The motion picture industry has a need for a process that economically repackages these assets in a manner suitable for long-term storage, yet retains an organization of the assets that support efficient editing at some future time.

There is an additional need for the casual browsing and inspection of the assets. Presently, because of the quantity of material (many hundreds of boxes for each of thousands of movies), the manner of organization (cryptic abbreviations on and in the boxes), the relative fragility of the physical media (even casual handling can result in a damaged negative), and the location of long-term storage (rarely near the studio), the assets are not readily available, and cannot be effectively examined.

Such archived assets may be of particular value when a previously edited version of a motion picture is to be modified for some other release, for instance, when the theatrical version of a movie is to be re-edited for release on television. There is a need to quickly and efficiently identify, review, and establish the availability of potential alternative material for portions of the motion picture not suitable for a broadcast audience. This need includes both alternate takes or shots within individual scenes, and rapid identification of entire scenes not included in the previously edited version.

The present invention satisfies these and other needs and provides further related advantages.

### OBJECTS AND SUMMARY OF THE INVENTION

The present invention relates generally to the storage of the media elements produced in the making of a motion picture film, including the A-negative trims and outs, B-negative, audio tapes, work print, script, associated notes, and the like, while preserving information about the original relationships, synchronization, and physical location of related elements, and providing thumbnail images and digital representations of these elements.

It is an object of the present invention to dramatically reduce the volume of storage required by these media elements, yet to retain or enhance their organization and accessibility.

Film elements are consolidated into contiguous rolls (“element consolidation” or “EC rolls”) and the labels, notes, and identifying marks (including edge numbers, key numbers, slates, etc.), previously associated with those elements, are associated with the new EC roll, and a footage offset into that roll (where appropriate) are captured in a log.

It is an object of the present invention to maintain the security and proprietary nature of the media assets. The log of the present invention, preferably implemented as a database, is arranged to allow access of a studio's media assets only to users of the system authorized by the studio. It is also an object of the present invention to allow a studio to manage access to and security of their media assets independently of the balance of this invention's apparatus.

It is an object of this invention to assimilate the script, and any notes related to the production, in any order they may be acquired.

The database provides for the acquisition and logging of script pages and for the ability to use the script and other notes as a means of navigating the assets of the motion picture. Conversely, the script can be navigated by the motion picture, or its media assets.

It is an object of the present invention to dramatically improve the ability to browse, search, compare, and examine film elements, both rapidly and economically.

Each EC roll may be converted to video, and/or digitized, providing a less fragile representation of the EC roll contents that is also freely transportable or transmittable. This invention provides that video or digitized version of an EC roll may be stored at full resolution, but can also be highly compressed.

Information about the scenes in an edited version of the motion picture is entered and stored in the database. The database can thus be accessed by playing the edited version of the motion picture, and provide ready access to the corresponding script pages, notes, and available alternative takes.

It is an object of this invention to provide a simple user interface, to allow quick, organized access to the entirety of the archive's holdings.

The interface provided by this invention allows materials to be identified based on an edited version of the motion picture, the script, and/or a scene number; and once identified, immediately viewed.

It is an object of this invention to overcome the propensity of material to become lost and inaccessible when it is incorrectly categorized or misidentified as a result of human error.

The interface of this invention includes a mechanism for locating media that, due to human error, is not otherwise completely or correctly cross-referenced within the database.

It is an object of this invention to provide synchronized sound and picture, whenever the two related assets have been entered into the system; regardless of the order in which they are entered, and without operator regard to whether the other has been already entered.

When necessary, this apparatus is capable of dynamically linking the picture and sound to form a complete presentation of a selected take. However, if only one or the other asset has so far been made available to the system, then only that available asset will be presented.

These and other features and advantages of the invention will be more readily apparent upon reading the following description of a preferred exemplified embodiment of the invention and upon reference to the accompanying drawings.

### BRIEF DESCRIPTION OF THE DRAWINGS

The aspects of the present invention will be apparent upon consideration of the following detailed description taken in conjunction with the accompanying drawings, in which like referenced characters refer to like parts throughout, and in which:

FIG. 1 is a detailed block diagram of the process for consolidating media elements;

FIG. 2 depicts an element consolidation roll as the first element is being added;

FIG. 3 shows the same element consolidation roll nearing completion;

FIG. 4 illustrates the slate (or “clapper”) of the prior art, as a source for identifying information;

FIG. 5 is a representation of various events of note that may be captured in a film asset;

FIG. 6 is a portion of a database that administers access to movie assets;

FIG. 7 is a portion of the database that records script pages, similar records, and notes;

FIG. 8 is a portion of the database implementing the log that records the existence, nature, and location of a movie's physical media assets, the position of meaningful events within those assets, and digitized representations of those assets and events;

FIG. 9 is a graphical user interface showing alternate takes and navigation via a previously edited version of the motion picture;

FIG. 10 is a mode of the user interface showing navigation of or by the script; and

FIG. 11 is an exemplary architecture for a distributed embodiment of the invention, including the option for studio authority and physical control over their own media assets.

While the invention will be described and disclosed in connection with certain preferred embodiments and procedures, it is not intended to limit the invention to those specific embodiments. Rather it is intended to cover all such alternative embodiments and modifications as fall within the spirit and scope of the invention.

### DETAILED DESCRIPTION OF THE INVENTION

The core of the present invention is the method for building of “Element Consolidation,” or “EC” rolls and the generation of a usable index to them. This provides the significant reduction in the physical volume of archived studio film assets, but preserves critical notations and provides the record-keeping necessary for quick retrieval of any specific piece of film or soundtrack.

Digitized representations of the EC rolls and other crucial assets (e.g. sound rolls) allows a computerized version of the index to provide an convenience, informative, meaningful, and browsable index to the asset collection.

This detailed description first discusses the construction of an EC roll, including the capture of pertinent record-keeping information. This is followed by a description of the digitization of pertinent assets to be retained; and a discussion of a database suitable for record-keeping and access. Finally, a user interface for such access and a recommended network architecture is provided.

Building Element Consolidation Rolls

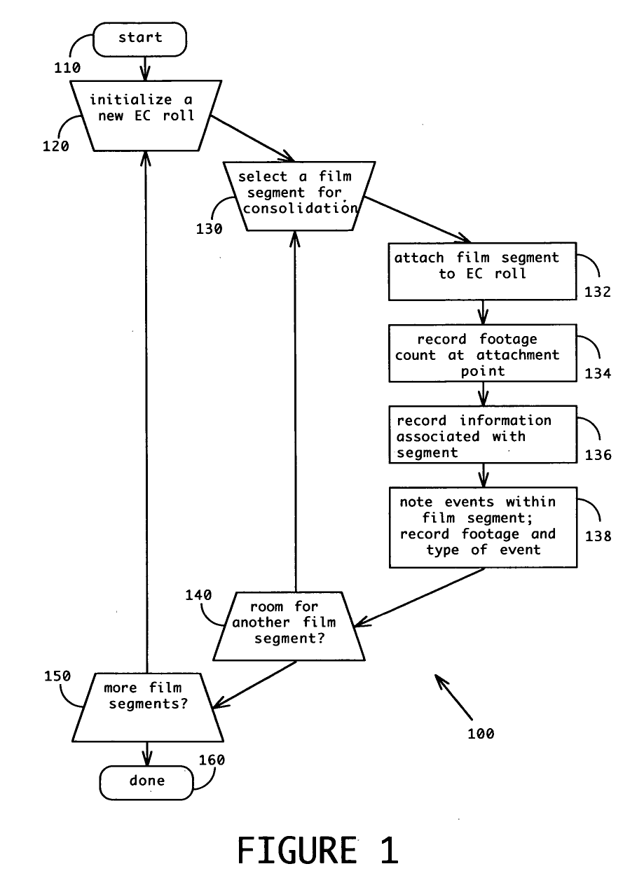

Referring to FIG. 1, the element consolidation process, or “EC process” 100 begins when a studio has resolved to have the media assets of a motion picture consolidated to minimize the volume of those assets.

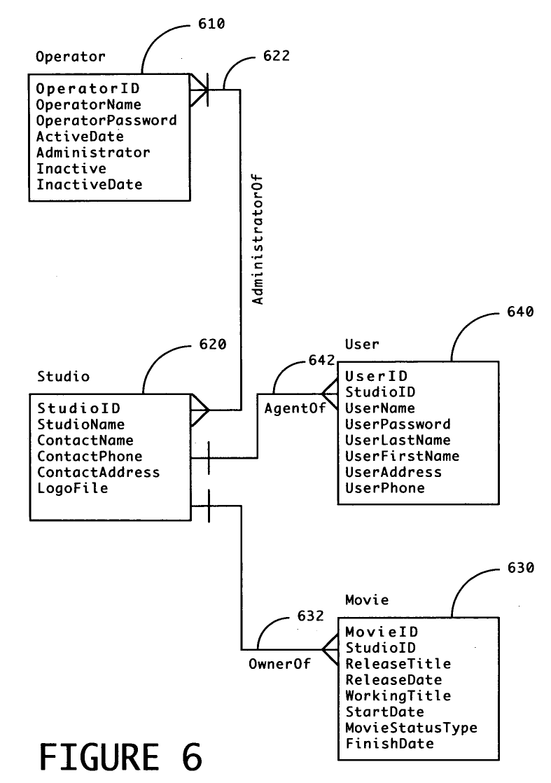

At the start step 110, the appropriate records (shown later in the discussion of FIG. 6) are initialized, as necessary, for the studio, the system operators servicing the studio's account and performing the EC work, and finally, the identification of the movie itself.

Assets for the movie begin to be retrieved from storage, and after careful unpacking and cleaning as necessary and preferably according to best practice in the art, the film assets are ready to be built into the EC rolls of the movie.

In step 120, a new EC roll is initialized prepared.

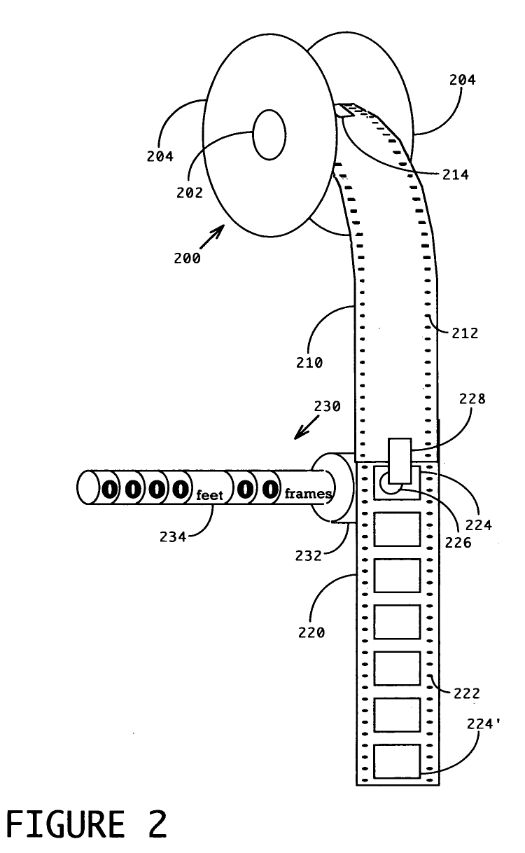

FIG. 2 illustrates the configuration of this EC roll 200 as step 132 is executed for the first time with respect to this EC roll.

Still in step 120, a film leader 210, having sprocket holes 212, is seen attached to empty core 202, preferably by adhesive tape 214. The EC roll 200 is mounted on a rewind (not shown) of the prior art. EC roll 200 is designated with a unique EC roll identifier, which is preferably noted on film leader 210. This EC roll identifier becomes the name by which this new constructed asset is subsequently referenced.

Synchronizer (“sync block”) 230, is representative of prior art equipment such as the one and two-gang models provided by J&R Film/Moviola of Hollywood, Calif. Synchronizer 230 contains sprocket wheel 232 with pins (not shown) to positively engage sprocket holes in film. Synchronizer 230 also has clamps and guides (not shown for clarity) that direct and hold film to maintain that positive engagement. Footage counter 234 is connected to sprocket wheel 232 to read out the precise film footage passing through the synchronizer. Footage counter 234 is adjusted to read zero.

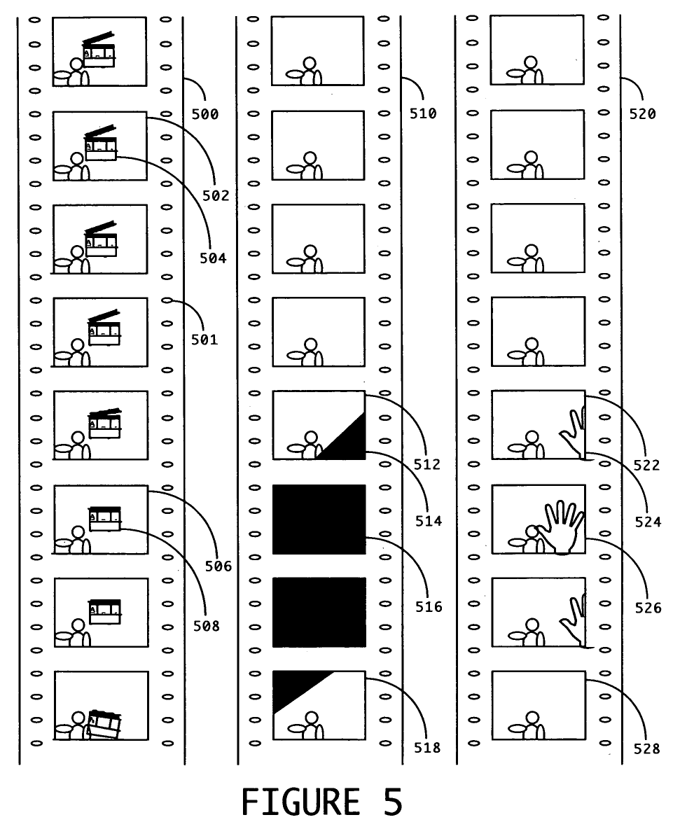

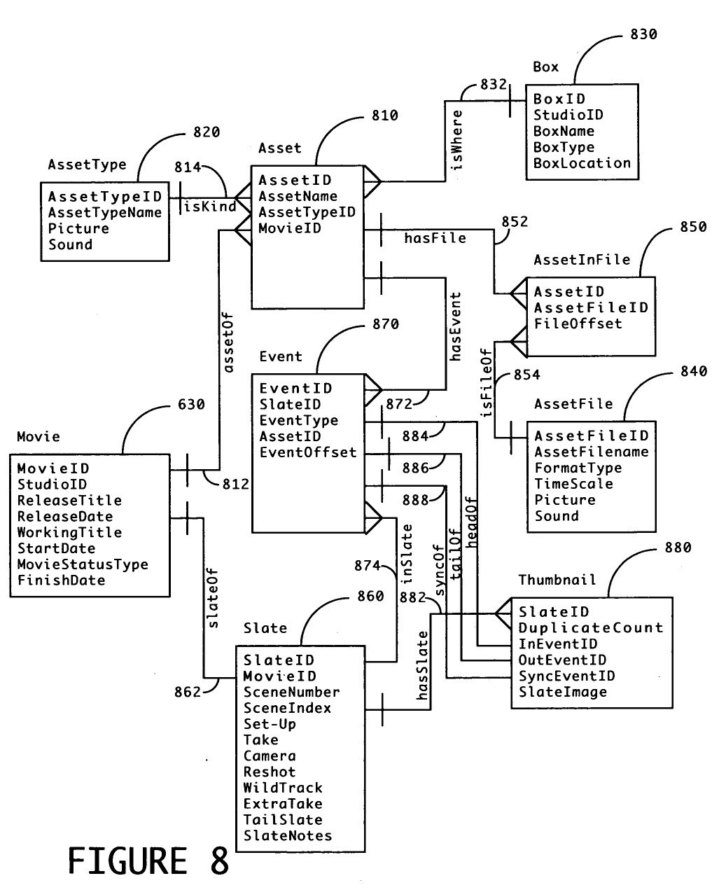

Preferably, footage counter 234 is electrically readable by a computer (not shown) for direct input into the database when significant events are encountered (discussed below in conjunction with FIGS. 5 and 8). Such a computer readable footage counter is provided by the Digisync Film Barcode Reader product, historically manufactured by Research in Motion, Ltd. of Ontario, Canada; and now available from The Filmlab Group of Stokenchurch, England.

The reel sides 204 flank core 202, and serve as guides and provide support to EC roll 200 as it fills up. However, for economy and compactness, the reel sides 204 may comprise a split reel or are preferably part of a knee action negative rewind (such as model NRU-2L by Hollywood Film Company of Los Angeles, Calif.) and thus are later detached from EC roll 200.

In the first execution of step 130 for EC roll 200, first film segment 220 is selected.

In the first execution of step 132 for EC roll 200, first film segment 220 is attached to leader 210 with adhesive tape 228. Leader 210 and first film segment 220 overlap by two perfs of leader and two perfs of negative, or a half frame of each. This overlap held by tape 228 is eliminated when the two perfs (one half frame) of each is cut off during the creation of a durable splice (preferably a hot splice), but the relationship between the adjacent pieces of film will remain the same. Suitable techniques for splicing are well know in the art.

Alternatively, a durable splice can be provided at this time, however it may be more efficient to defer the splicing step until later.

Note that in-every occurrence of step 132, the film segment being attached to EC roll 200 is attached with a consistent orientation. At the time of assembly, an orientation of “tail-out” is preferable, but a “head-out” orientation may be selected. The term “head-out” derives from the most common orientation of film in a camera or projector, where film flows in the direction in the direction of the film subject's head (assuming a standing subject), with the subject's feet trailing (In fact, the term “tail-out” was originally “foot-out”). A film roll ready for projection is wound head-out. A roll can always be re-wound to reverse its orientation.

At this time, and only for first film segment 220, a start hole 226 may be punched through first whole frame 224. This is a technique well known in the art to convey the first frame information unambiguously to individuals who subsequently handle EC roll 200. This first frame information provided by start hole 226 is particularly useful when the EC roll 200 is subsequently being converted to video or digitized.

First film segment 220 is locked into synchronizer 230 by the clamps and guides (previously mentioned, but not shown) such that the sprocket holes 222 engage the pins (not shown) of sprocket wheel 232, and so that footage counter 234 continues to read zero, while the first whole frame 224 of film segment 220 is centered in synchronizer 230.

In this fashion, first frame 224 is considered to have a footage count of zero. Alternatively, a different convention might place the zero count at a hole punched in the leader 210, in such a case, first film segment 220 will undergo less special handling, and may be treated more like subsequent film segments, discussed below.

In step 134, a record is made of the current reading of footage counter 234, and the current event: the beginning of a segment, which will also always be a splice. This record must reference EC roll 200. How events so recorded are subsequently organized, is discussed below, in conjunction with FIG. 8.

Recording of these event records is preferably achieved by a computer application (not shown) specially adapted to the purpose.

At the start of an EC roll 200, in step 120, the identity of the EC roll 200 can be entered into the application. In an alternative embodiment, this application can generate and provide the name for the new EC roll. The application may print bar-coded labels to be attached to leader 210, or if bar-coded labels were made available from another source (e.g. pre-printed unique bar-coded labels), the application could read the bar-code via keyboard wedge, commonly known to the art.

In step 134, and at each event found in step 138 discussed below, the reading of footage counter 234 is entered into the application, along with the type of the event. Preferably, the footage count can be captured automatically by the application. An example of a commercially available application that can automatically capture the current footage count and accept keyboard entry of event type is Excalibur, by The Filmlab Group, Stokenchurch, England.

Further, since the number of event types is small, the event type may be effectively entered into the application by voice command. Such voice command activated selection is well known, and easily accessible to application programmers, for instance in the Microsoft Speech Application Programming Interface for Windows 95 and later, produced by Microsoft Corporation, Redmond, Wash.

If the film segment selected in step 130 was associated with any notes, tags, or labels, they are recorded in step 136. In the Excalibur software product mentioned above, these notes can be recorded in the comment field for the event.

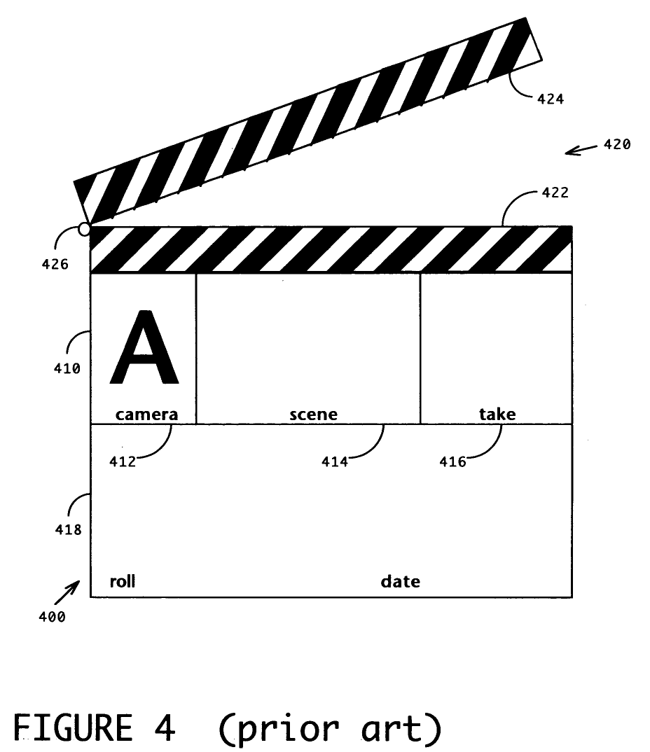

In step 138, as the leader 210 and film segment 220 are wound onto EC roll 200, up until frame 224′ approaches synchronizer 230, the operator watches for events occurring within film segment 220. Events include splices (if film segment 220 contains an already embedded splice), slates, camera flashes, series waves, etc. The nature and meaning of such events will be discussed below, in conjunction with FIGS. 4 & 5.

In step 140, an assessment is made. Most frequently, the determination will be that there is sufficient room for a film segment following the first film segment 220, and the process iterates at step 130 with the selection of a next film segment.

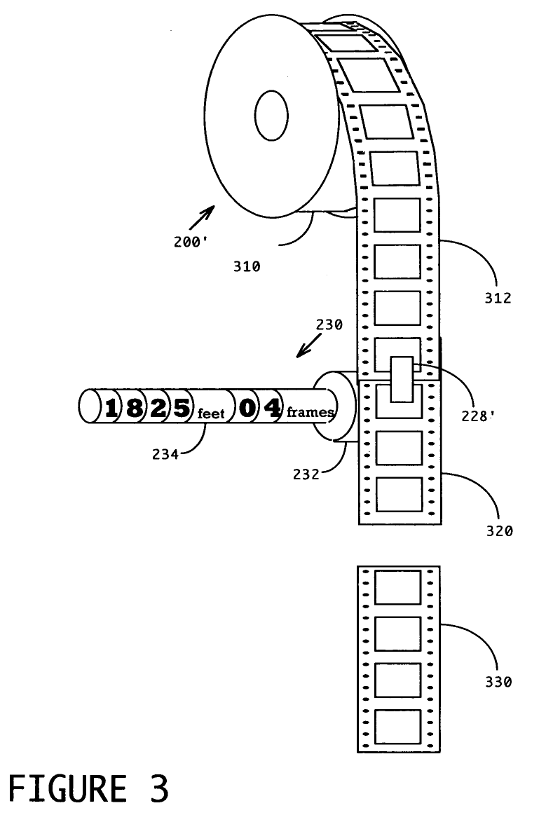

Consider the repetition of steps 130, 132, 134, 136, 138, and 140, in the context of FIG. 3.

In FIG. 3, in-process EC roll 200′ has the leader and at least the first film segment wound up, and represented as film coil 310, having tail film segment 312.

In a repeat of step 130, next film segment 320 was selected. At this point in the process, tail segment 312 would still be in synchronizer 230.

In a repeat of step 132, next film segment 320 would be attached to tail segment 312, with a half frame of overlap of each film segment, and held with tape 228′.

In a repeat of step 134, the overlap would be carefully fed through the synchronizer 230, and reading of footage counter 234 would be made for the first frame of next film segment 320, and recorded as a splice event. This is the precise moment represented by FIG. 3.

Alternatively, the reading from the footage counter 234 may be represented as a frame count, or time, or other linear measure.

In step 136, and notes for film segment 320 are recorded.

In step 138, film segment 320 is rolled through synchronizer 230 and events in film segment 320, if any, are noted and recorded with the footage count where they occur.

In step 140, if it appears that EC roll 200′ is full, that is, film coil 310 is so large that there is not likely room to add next film segment 330, then EC roll 200′ is complete.

Preferably, the decisions made in steps 130 (selection of a next film segment) and 140 (whether to conclude an EC roll) should take into account the arrangement and associations of the film segments as they are found. Any piece of B-Negative (film that was never used by an editor) will be whole scenes, and special consideration is rarely needed. Any “out,” a scene unused by the editor in its entirety, is similarly whole and rarely requires special consideration. Not the same, however, as “trims.”

Trims are the pieces removed from a take that is used in the edited motion picture, though the removed pieces are not. Trims include the head of a take (including the pre-roll and slate—neither are ever used in a movie), the tail of a take (including the director's shout of “CUT!”-never used in a movie), and little pieces of the take not used because some alternate footage was selected instead. An example of this would involve a scene of two characters conversing. The master shot would include takes showing the two characters having their conversation. Alternate set-ups would include close-ups of each character addressing the other. In the final edit, the selected take of the master shot will probably have sections removed, and have pieces of the close-up takes inter-cut. The removed sections, and the unused portions of the close-ups, form trims.

Negative Cutters are fastidious people. In all likelihood, the head and tail of a take are attached to each other, and all the intermediate trims are attached—probably in-order, and probably held by a rubber band. This careful gathering of the take's remains represents a useful organization of the pieces that should be retained.

When selecting a next film segment in step 130, such a collection of trims is preferably selected when there is room remaining on the EC roll for the entire collection. Otherwise, the collection will become split across two EC rolls. Such a split, while not fatal, is certainly inelegant.

EC rolls are preferably built to an industry standard maximum, typically 2000 feet. Many telecine machines and editing tables cannot manage rolls larger than this.

In step 150, EC roll 200′ is completed. A final piece of tail leader (not shown), sufficiently long to provide protection for the EC roll, is attached (taped) to last film segment 320 and wound up. The same EC roll identifier assigned in step 120 is preferably recorded on the tail leader. EC roll 200′ is removed from the rewind.

Preferably, at this time, the splices within EC roll 220′ can be completed. Well known in the art, the finished splices are durable, and essentially as strong as the original uncut film. Adhesive tape 228 and 228′, previously holding the temporary splices in place, is discarded. The one half frame's worth of overlap on each segment, at each temporary splice, is cut so that a whole frame remains to either side of the splice, and the newly cut edges are abutted and permanently joined by tape, or cement and (preferably) heated until they are fused. Once all the splices in the EC roll are made permanent, the EC roll may be transferred to video or digitized on a telecine. Afterwards, the EC roll is ready for storage, preferably in a container appropriate to the industry's best practices, and labeled with the EC roll identifier.

Alternatively, lossless splices can be employed that do not destroy the frame at the joined ends of the film segment. However, this typically represents more time and expense in the splicing process, and may not be warranted for most material. Still, especially for trims, it may be valuable to use lossless splices in case some future extension of a take used in the movie becomes desirable.

A variation of this method would be to defer all or some of steps 134 and/or 138 until a later time. Specifically, it may be easier to record some details of some events at a time other than when the frame related to the event is lying clamped in the synchronizer. Such circumstances will be apparent from the discussion relating to FIG. 5.

FIG. 4 show slate 400 of the prior art, also known as a clapper. Typically, each camera of a production is outfitted with one or more slates 400 specific to it. In the take record area 410, information about specific takes is written. The camera designation 412, usually consistent through an entire production, is permanently recorded the slate 400. Scene number, including set-up designation, is written in scene box 414 and will be updated for each set-up. The take number is written in take box 416, and will be start at one with each new set-up, and incremented with each take. Production information area 418 may include such constant information as the movie title (or working title), the director's name, the cinematographer's name. Other information that changes only once or twice per day, such as the date and camera roll number may be recorded here. Occasionally, other information such as lens focal length, or camera speed (if non-standard, for example a higher frame rate to generate a slow motion effect) may be recorded here, or may be recorded in a separate log.

The clapper bar 420 consists of a movable bar 424 connected to the top of the slate 422 by hinge 426. For each take, while the camera is running, the slate is placed into the field of view of the camera and provides a visual record identifying the take. The clapper bar 420 is opened (as shown in FIG. 4), and while the camera and sound equipment are running, the movable bar 424 is rapidly swung to impact top of slate 422, causing an audible clap, which is easily found in the sound recording.

In FIG. 5, film segment 500, having sprocket holes 501, illustrates the photographic record of a slate 400 being clapped. Frame 502 shows picture 504 of slate 400 in the open state. The instant that slate 400 was closed is recorded in frame 506, as picture 508 of slate 400 is the first showing slate 400 in the closed state. Frame 506 would be designated in step 138 as a “slate event.”

Film segment 510 illustrates the photographic record resulting from the camera being stopped. Frame 512 shows burn 514, which results from overexposure of the film as the camera slows down when being stopped. (Depending on the camera, and the precise timing of the camera stoppage, the overexposure burn may affect only part of the frame, or the whole frame may be overexposed). Frame 518 includes a complementary burn, as occurs when the camera is being restarted, usually for the next take. Frame 516 is one of usually several frames that are completely burned by overexposure—no image remains. In original camera negative film, frame 516 is completely black. Any one such frame 516 between frames 512 and 518 is designated in step 138 as having a “flash event.”

Flash events are useful for finding the first and last frames of film surrounding a take. An advantage of the flash event is that some candid events may be captured in the footage surrounding the formal acting within a take, such as a famous actor breaking character before the clap, or following a gaff in the middle of a scene.

Flash events are also useful as hints for identifying separations between takes if a slate was not correctly used.

Film segment 520 illustrates the photographic record of a common way of separating takes when the production crew is in a hurry, or when slates are inconvenient. A slate (not illustrated in film segment 520) identifying the scene is usually captured. Such a slate may indicate that it is slating a “series.” During the shooting of a series shot, the camera continues to roll and no further slates are introduced. Takes are separated by the camera operator or the assistant waving a hand in front of the lens. Frame 522 shows picture 524 of a hand entering the camera's field of view. One or more frames 526 will have the hand wholly in view of the camera. Frame 528, showing no hand begins the next take. In step 138, one frame 526 from frame 522 up to frame 528 would be designated as a “wave event.”

The details necessary to completely record such events, especially the scene, take, camera, roll, date, etc. information from picture 508 of slate 400, may be awkward to gather while the EC roll is being built. In such a circumstance, it is sufficient to note the location of the event. In a more convenient circumstance the data can be gathered and added to the original event record. For instance, after the EC roll has been transferred to video or digitized on a telecine, it is well known how to access a particular footage mark in the video transfer.

For example, the Excalibur product can translate the footage count of an event in an EC roll into the SMPTE timecode specifying the corresponding frame in the video transfer of that roll. With a video player having a SMPTE timecode readout, such as the Sony BVW-65 BetaCam/SP by Sony Electronics, Inc. of Park Ridge, N.J., or a computer-based digital video console, such as that provided in the Final Cut Pro software by Apple, Inc, of Cupertino, Calif.; it is an easy matter to rapidly display the event frame on a monitor.

Additional event types may include embedded splices (not shown), where a pre-existing splice is encountered within film segment 220 or 320 being attached to EC roll 200′.

Key numbers (not shown) occur periodically along the edge of each film segment 220 and 320. It is well know in the art that, regardless of the actual position of key numbers in a film segment, a key number can be calculated for any frame in the film segment. Preferably, the first occurrence of a key number in each film segment 220 and 320 is recorded as an event in the frame associated with the sprocket hole the key number denotes. The interpretation of key numbers and the frame denoted is well known and published, for instance in Eastman KEYKODE™ Numbers: Guide to Film and Video Postproduction, 1996, published by Eastman Kodak Company, Rochester, N.Y. Preferably, an application used to record events is configure to automatically capture the first key number, as is the commercially available product Excalibur, previously mentioned, when using the Digisync Film Barcode Reader hardware, and reading film bearing the machine readable, bar-coded KEYKODE key numbers.

Further, a discontinuity in the key numbers represents an event. Such a discontinuity is indicative of a splice having passed not more than about a foot prior. If a corresponding splice event was logged, then the new (discontinuous) key number applies to the film following that splice. If no corresponding splice event was logged, then either a notice can-alert the operator to find and log that splice, or the application may infer the approximate location of the splice (e.g. about six inches, or 8 frames, earlier). A consistency checks such as this is one of the many valuable capabilities provided by logging the key numbers.

Automatic logging of the key numbers also reduces the burden of step 136, as often, the notes associated with film segments 220 and 320 will include key number information.

It will be recognized by those skilled in the art that the process of building of an EC roll is composed of familiar manipulations of film and the recording of commonly observed in-film events. The process of building an EC roll employs the same technical skills necessary to build a lab roll and the associated lab roll report. There are certain extensions, such as the more careful noting and logging of flash and wave events, and a lab roll will never have a pre-existing splice. The re-assembly of trims in a take (to the extent practical) onto an EC roll is similar to and requires the same attention to detail as the restoring of trims to a KEM roll (a term of art referring to the film roll prepared for use with a specific brand of flatbed class of editing stations). The departure here is that for an EC roll, it is not necessary to insert filler into the gap where one or more frames have been removed, while that is an option, it will increase the number of reels to be warehoused by at least five (i.e., the length of the edited motion picture), which will be about 5% (i.e., the shooting ratio).

Contrary to the prior art motion picture archival practice, EC rolls have been found empirically to take up less than half (usually far less) than the traditional storage of B-Negative and the A-Negative (circle take trims & outs).

There is a third class of film asset, for which we have coined the term “C-Negative,” which includes all of the optical source, intermediate steps, and final results that are created when building opticals. This includes simple opticals such as fades, dissolves, superimposures, and titles, and the whole range of special effects opticals such as blue-screen, matte photography, and CGI (computer generated images).

The physical assets of many of today's CGI special effects will be only source footage (which may be classified as A-negative) and the final result. All the intermediate steps may have existed only as computer data—in fact, in some circumstances, even the source is computer-generated and there is no physical asset other than the final result.

Because of the thoughtfulness that precedes the significant expense of opticals, opticals almost always correspond to circle takes, and almost always end up in the finished film. Therefore, with the exception of intermediate steps (which, at the studio's discretion may be considered disposable), all opticals could be classified as A-negative. However, for some effects-laden films, the C-negative designation is a useful distinction.

Regardless of classification, film assets from opticals may be consolidated in accordance to FIG. 1.

The handling of sound in the course of producing a motion picture has involved making an audio tape recording of the takes. Usually, a whole day's takes easily fit on a single sound roll, as tape is consumed less rapidly than camera film, and is more compact, too. For the preparation of dailies, prior to non-linear editing technology, a copy of the sound rolls is made (for the circle takes only) onto “mag,” the soundtrack stock that is the same shape as camera film, but which has some or all of one side covered with a magnetically recordable coating. When properly placed into a synchronizer having a second a sprocket wheel (not shown) adjacent to 232, the sound is advanced and maintained in synch with the picture on the film clamped to wheel 232—hence the name, “synchronizer.”

To the extent that original sound rolls are not available, the mag soundtrack can be assembled into EC rolls according to the process given for FIG. 1. Here, step 138 would identify audio-related events, rather than film-related events such as those shown in FIG. 5. The two key audio-related events are the “audio slate” events and the “audio clap” event. An audio slate event occurs when a sound technician speaks the scene, set-up, and take designation of the take onto the sound roll. An audio clap event is the audio recording of the sound of the clapper.

However, it is almost always the case that the original sound rolls are available in their entirety. Thus, the mag soundtrack is usually superfluous and may be discarded. Since the mag soundtrack is almost precisely the same physical volume as the A-negative (typically ⅔ of the total A-+B-negative film volume), this represents a significant volume reduction.

If the original sound rolls are available, then for the purposes of EC consolidation process 100, the pre-existing sound rolls may be treated as EC-rolls comprised of a single-segment. The record-keeping of steps 134, 136, and 138 would still be performed.

Transferring Assets to Digital Files

The preferable search mechanism for the assets in the EC rolls requires that they and certain other records be transferred to digital files. These files, with an appropriate database to relate them, can provide an efficient, reliable, comprehensive, and human-error tolerant search mechanism.

EC rolls, whether A, B, C-negative, or sound, can be transferred to digital files. However, different alternative selections are available for each. Some of the alternatives can represent significant savings over the others. Further, for some of the assets, some or all of the activities of step 138 are preferably carried out using the digitized form of the asset.

Generally, B-negative has never been synchronized to audio, and never been assembled into dailies rolls, nor printed. As such, the preferred mechanism for achieving a digitization of the B-negative is to run the EC roll through a telecine. The output of the telecine may go directly to a digital file, or may produce a videotape intermediate, which is subsequently digitized.

As commonly practiced in the art, the timecode of the telecine transfer corresponding to the hole 226 punched through first frame 224 of first segment 220 (or alternatively, onto leader 210), will have a specific value, typically near the top of some hour, as in “xx:00:30:00” (where xx represents the hours, the first “00” represents the minutes of the timecode, the second “00” represents seconds, and the third “00” represents frame count within the seconds) The “xx” hour value designated in the timecode may be “01”, or it may be assigned some other value. Prior to this timecode, the transfer preferably includes a sample of some color bars or other common header signal, and a viewable title card.

When transferring to videotape, to achieve an economy in the number of videotapes required, the telecine operator may be requested to transfer multiple EC rolls to a single videotape. Since an EC roll contains up to 2000 feet of film having a running time of 22.2 minutes, three EC rolls may be transferred to a videotape slightly longer than one hour. If this is done, each the second and third EC rolls are preferably transferred to tape such that their respective punched holes 226 fall at prescribed timecodes, such as “xx:23:00:00” for the second EC roll, and “xx:45:30:00” for the third. Preferably, in the 15 seconds prior to each of the second and third EC rolls, a viewable title is recorded. When the telecine is transferring EC rolls directly to digital file, only one EC roll per file is preferred. However, if videotaped telecine transfers are being digitized, then the relationship between the multiple EC rolls transferred to a single tape is maintained and their respective offsets within the file are noted, as described below in conjunction with FIG. 8.

Normally, since the dynamic range of video equipment is so inferior to that of film negative, each separate film take requires adjustment and color correction in the telecine process, to provide the best possible transfer. However, since these transfers will only be used as an index for the EC rolls, and not used to judge whether a scene needs to be re-shot, the take-by-take adjustment is usually an unnecessary expense. For the transfer of EC rolls, contrary to the normal operation of a telecine transfer, the default transfer adjustments are will be generally adequate for this purpose and no per-take adjustment is required.

An even greater savings in telecine costs is commonly available with A-negative. For the past several decades, it has been common practice as the dailies reels are printed, to generate one or more video transfers of the dailies. The editor's copy of these, called the “dailies master tape”, are generally saved, and if available in their entirety, represent a better quality transfer than would normally be accorded an A-negative EC roll. Further, since the A-negative EC rolls only contain trims and outs, and not the portions that were actually used in the edited film, the dailies tapes will have greater continuity. Also, dailies tapes already contain synchronized sound—something that is not true of B-negative transfers (though the present invention has a remedy for this, below). Synchronized sound is difficult to achieve with trims, because the original camera negative for the take has been chopped up and no longer matches the audio on the sound roll (a solution for this too, is provided below), thus the simplicity and cost savings of digitizing the dailies tapes is very attractive.

If the dailies rolls are present in their entirety, then they may be digitized directly. If this approach is used, then record-keeping equivalent to that produced by steps 134, 136, and 138 must be provided. This record-keeping can be produced manually, in accordance with FIG. 1, treating the dailies tape as a single-segment EC roll. Even more preferable, it is often the case that the dailies report logs are available, in paper or electronic form. In such a case, it will be sufficient to enter or import these logs to the database. In this way, there will be a database entry for each take in the A-negative and a corresponding database entry in the dailies; at least, almost always. Exceptions will occur because it is not assured that the trims and outs of every circle take made it back to the boxes of A-negative that were originally stored and subsequently delivered for element consolidation.

It is also the case that the important pieces of C-negative (typically the source films—if any—and the results of the optical process) were screened in a dailies format. If so, these elements are captured to digitized file as part of the dailies. Generally, it is unnecessary to transfer the balance of the C-negative, though this can be done. If not done, the portion of the C-negative not available via the dailies will only be indexed in the database, and will not be available for browsing via the visual user interface described below. Usually, this is acceptable.

If telecine transfer savings are not at issue, or if a visual index of the actual A-negative EC rolls or C-negative EC rolls is considered crucial, then these EC rolls can be transferred just as the B-negative EC rolls.

Whether it has been necessary to assemble EC rolls for the mag soundtrack, or the original sound rolls are available, these can be digitized. Digitization of audio is considerably less expensive than telecine. Further, the steps 134, 136, and 138 can be performed, usually with greater efficiency, on the digitized sound file rather than on the physical sound asset (EC roll or sound roll). In either case, the identification in step 134 of the first point preferably references the start of the digitized file.

For the purpose of long-term archive, either the original sound rolls can be retained, or the digitized sound files can be archived. Preferably, for the purposes of economical storage, the mag soundtrack is not retained.

Database Tracking of Element Consolidation

By its nature, EC roll construction takes place in situations where total control over the sequencing and availability of the assets to be consolidated is not assured. Paper-based logbooks used in assembling dailies rolls or lab reports, and quite familiar to those practicing the art, provide minimal value in the context of building EC rolls, since when building EC rolls the assets are frequently presented out of order. Such paper-based logs would provide a haphazard, hard-to-search organization of film segment identification records.

To facilitate the building of EC rolls, a database is particularly valuable. Entry of notes and records into the database provides a means to capture these notes and provide a reporting capability that makes the assets stored in the EC rolls more accessible.

Once the records are entered into the database, a meaningfully sorted hardcopy report may be generated and stored with the physical assets. Preferably, the computer-based database is retained as the asset's primary search method.

FIG. 6 illustrates the administrative portion of a database suitable for element consolidation. In this Internet-enabled digital age, studios are particularly concerned about the security of their intellectual property, especially their film assets.

The database illustrated presumes that assets from multiple organizations (studios) are contained in a single database. Even if this system were to be used by a single studio, individual production companies might have distinct access privileges as show here. While other organizations could be appropriate given a specific business situation, this database is considered the preferable embodiment of the present invention.

Operator table 610 contains account information for operators and technicians working on element consolidation. Besides a unique identifier for the operator (OperatorID) used by the database, such a table preferably includes the real name of the operator (Operator Name), and the operator's password (Operator Password). Permissions of each operator may be recorded, such as an effective activation date (ActiveDate) and a flag to indicate whether the operator has administrative privileges (Administrator). To allow an operator's account to be deactivated, as when an employee leaves the company, a flag indicates deactivation (Inactive) and that date may be recorded (InactiveDate).

Studio table 620 contains client information about studios using the system. Each studio is associated with a unique identifier (StudioID in table 620). The studio's name (StudioName) and primary contact information (ContactName, ContactPhone, ContactAddress) provide key business information, limited here for clarity, though much more will probably be useful (e.g. billing address, contract administration information, etc.)

Additionally, as a component in a user interface (discussed below), certain studio-specific graphics may be associated with a studio, for example a studio logo (LogoFile). A logo may be used to graphically establish the studio's identity when a user is working with assets of that studio. Such a logo may be stored in a JPEG file format, for use in, and familiar to designers of, web-based applications.

A specific administration relationship 622 (AdministratorOf) identifies those operators in Operator table 610 who have been designated as administrators for specific studios in Studio table 620. While an operator may be authorized to work on zero or more studio's assets, each studio preferably has one or more administrators.

Note that the AdminstratorOf relationship 622 is not related to the Administrator flag in Operator table 610: The Administrator flag authorizes an operator to add and activate new operators, deactivate old operators, and to add new studios, and to set the initial AdministoratorOf relationship 622 for new studios, and add or delete those administrators for existing studios.

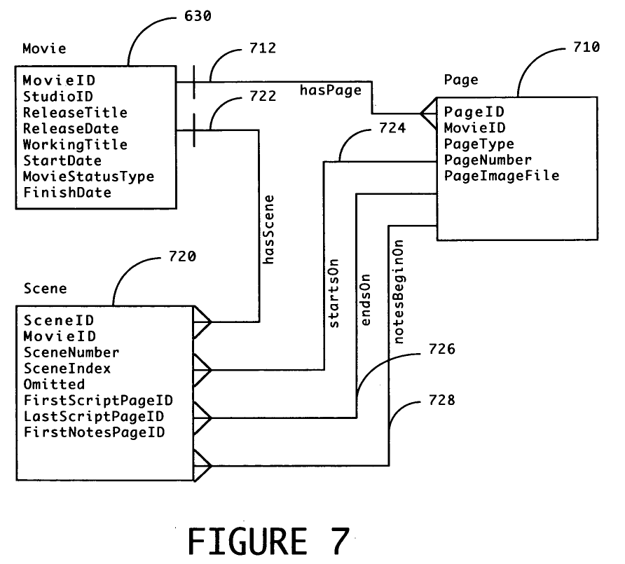

Movie table 630 is the link between a studio and all its assets stored in the system. Any asset to be entered into the system must first be associated with a movie. Each movie is uniquely identified (MovieID). The owning studio is noted (StudioID in table 630) to form the OwnerOf relationship 632. While each movie should have precisely one owning studio, each studio can own any number of movies. As the lynchpin for all subsequent asset entry and associations, Movie table 630 also appears in FIGS. 7 and 8.

Additional information about each movie may be stored by the system, such as the title (ReleaseTitle, WorkingTitle), the original release date (ReleaseDate).

The database preferably provides the ability to track project information about a movie's assets as they are assimilated into the system. Such fields as current status (MovieStatusType) and start and completion dates (StartDate, FinishDate) may represent this.

Those skilled in the art of workflow management data structures will recognize this as merely illustrative, and more elaborate work tracking records would be preferable. Further, the specific arrangement of these tables and relationships is intended to clearly convey an understanding of the purpose and operation of the database. For those skilled in the art of relational database design, formal analysis may find that this is not in a fully normalized form; however the methods for achieving such a configuration are well know.

User table 640 identifies persons who may have read access to a studio's assets. Each user is uniquely identified (UserID), and associated with a specific studio (StudioID in table 640) to form the AgentOf relationship 642. Each user has a username and password (UserName, UserPassword) used to authenticate their identity to the system, as well as typical outside-world identifying information (UserLastName, UserFirstName, UserAddress, and UserPhone). Optionally, this table could include specific information about a user's ability to order materials or work to be done, or otherwise incur expense for the studio.

Additional relationships are feasible, and in some circumstances may be needed. For example, relationships (not shown) could be included that give an operator or user explicit access to specific movies. Those skilled in the art will recognize such business rules can be implemented through relationships designed for the purpose without departing from the spirit of the present invention.

FIG. 7 illustrates a portion of the database suitable for capturing information related to paper-based notes, especially the lined (marked-up) script and notes compiled by the script supervisor. Other paper records, such as camera reports, sound reports, lab reports, dailies reports, editor reports, etc. may also captured here.

As an example, consider the importation of a lined script into the database. An image of each page of the script is obtained by scanning. For each such image, a record is made in Page table 710. Each page is uniquely identified (PageID) and the associated movie is noted (MovieID in table 710) to form the hasPage relationship 712. Every page should have exactly one associated movie, though a movie may have any number of associated pages. The type of page (PageType) is recorded, which in this case was said to be “Lined Script”. Within the lined script, the page scans are given a sequencing number (PageNumber) so that the system can easily identify the next or previous page. Lastly, the file containing the page image is recorded (PageImageFile). Implementation details will determine whether PageImageFile is merely a path name to an image stored external to the database, or if it is a BLOB (binary large object) stored internal to the database.

As each page is loaded in to the system, an operator can index the scenes mentioned on the page by adding to Scene table 720. Each record in Scene table 720 is given a unique identifier (SceneID) and linked to a specific movie (MovieID in table 720) to form hasScene relationship 722. Each scene will be linked to exactly one movie, but each movie can have any number of linked scenes.

As described above, each scene in a script has a number, but may also have a prefix to indicate that it had been added after the script was locked. The number portion of the scene would be entered in SceneNumber, while the prefix (if present) would be recorded in SceneIndex. If a scene is deleted from the production, the flag Omitted would be set. Optionally, a description of the scene's action might be stored here (not shown).

The simplest technique for associating the scene records of table 720 with page records in table 710 is by noting the pages of the script spanned by references to a scene. The relationships startsOn 724 and endsOn 726 indicate the range of consecutive pages in the script that provide coverage for a scene. Relationships 724 and 726 can be formed by the fields FirstScriptPageID and LastScriptPageID. Similarly, for script notes, the notesBeginOn relationship 728 can be formed by the FirstNotesPageID field.

This simple record is economical for entry by the operator, and it is effective for the vast majority of most scripts. Those skilled in the art will recognize that a more comprehensive index can be compiled, explicitly listing references to scenes made on each page of all documents. These indices, or even the page records themselves, might contain other fields such as the date page bears (if any).

An extremely comprehensive index may be obtained by having each script page image scanned by an optical character recognition program, to extract the original script text. Preferably, the images scanned for such a procedure are “clean”, that is, not a lined script or otherwise marked-up with handwritten notes. From the original text, script pages could be searched for and found based on character names, lines of dialog, names or descriptions of the location, etc., and traced to the appropriate scenes using the relationships to table 720.

FIG. 8 illustrates the portion of the database required for capturing the primary assets for a movie listed in Movie table 630.

Asset table 810 is used to track the existence of physical assets. Every physical asset is uniquely identified (AssetID), is tied to a specific movie (MovieID in table 810) to form the assetOf relationship 812, and has a human friendly name (AssetName). For a hypothetical movie “Hey Shorty!” made in 1995, such a asset name might @ uniformly begin with “HS95.” The type of asset is explicitly recorded, such as A-negative EC roll. If many distinct assets of a particular type exist, they may have natural sequence numbers (e.g. A-negative EC rolls 1-70). In such a case, the asset name could be formed by including a type designator “A” and the sequence number (e.g. “001” for the first one) to form the name: “HS95A001.”

Note that a similar naming convention could be used for page image files, where “HS95S175” might be the 175th page of the script for this hypothetical movie.

A consistent naming convention is strongly preferred for the purposes of readily generating human readable names for assets as they are generated. However, many assets arrive with names already given to them by the production company that created the assets. For instance, dailies master tapes (the videotapes made from each dailies reel and provided to the editor for use in his non-linear editing system) are generally already numbered. Further, due to internal inconsistencies in a production company (e.g. when a task is assigned to a new intern or assistants exchange roles) there may not be a uniformity in the pre-existing naming convention. For example, some dailies master tapes may be called out by a sequence number, some may be called out by their date, etc. In such cases, because other reference materials (e.g. editor reports) may call out these assets by their previously given name, these names should be retained, unaltered.

An additional field (not shown in table 810) can provide a internal sequence number (SeqNumber) for each asset of a specific type in a movie. This number can either be used to generate a human readable name as described above, or merely to assist in the management of otherwise unruly production-company-provided asset names. In one empirical example, each channel of the sound track of every take of every scene shot for a movie was provided as an original asset in a separate digital file. As such, there were over 10,000 files, each with (fortunately) unique names, but that only generally followed a company specific naming convention.

AssetType table 820 lists is effectively a dictionary for different kinds of assets. Each asset type is uniquely identified (AssetTypeID) and has a human readable name (AssetTypeName), such as “A-negative EC roll” or “Dailies Master Tape.” Each asset type is characterized by properties, such as flag fields Picture and Sound (both in table 820) which indicate whether an asset of a specific type provide either pictures only (as with an A-negative EC roll), or soundtrack only (as with a sound roll), or both (as with a dailies master tape).

Each asset in Asset table 810 has a single AssetTypeID, to form the is Kind relationship 814.

Note that Asset table 810 does not actually contain any assets, but is merely a record that an asset exists.

If an asset is a physical item, it has a physical location. This is expressed by the is where relationship 832 to Box table 830.

For example, a set of five EC rolls might be stored in a carton in a warehouse. The carton would be referenced internally by the database with identifier BoxID. The contents of each box preferably belong to a specific studio, identified by StudioID in table 830. Each box is given a human readable name or number (BoxName). Preferably, either this name or another identifier labels this box in machine readable form, such as a barcoded label (not separately shown in table 830). In this case, the box type might be “Carton; Film Rolls; Capacity 5.” The BoxLocation field would reference the warehouse. This illustrative example shows that information sufficient to direct a clerk to fetch an asset can be stored: the clerk can be told the name of the box, what it looks like, and where it is. A more detailed inventory tracking system would include rack and shelf numbers to pinpoint the box's exact location. Preferably, this database of the present invention merely tracks a BoxID number that is provided by and managed by an external, off-the-shelf inventory control system.

Preferably, each of the physical assets tracked in Asset table 810 is also available as one or more digitized files. For example, an A-negative EC roll asset would be available as a (silent) video media file. A sound roll asset would be available as an audio media file. AssetFile table 840 is used to record the existence of such files. Each is given a unique identifier (AssetFileID).

Each is associated with the filename (AssetFilename) of a digital file (e.g. “HS95A004.mov” might the digitized version of the fourth videotape from telecine process of the A-negative EC rolls). Alternatively, the digital file may be stored directly within the database as a BLOB.

The format of each AssetFile is noted (FormatType), for example a sound roll file might be available as a full-bandwidth digitized stereo production quality “.AIF” file, a highly compressed “.MP3” file, or a file suitable for streaming over the Internet such as a “.RA” Real Audio file by Real Networks of Seattle, Wash.

An asset may be simultaneously represented by several files of several formats, or duplicate formats, but varying resolutions. To track such association, the AssetInFile table 850 provides both the hasFile relationship 852 and is FileOf relationship 854. Each entry in AssetInFile table 850 corresponds to precisely one physical asset (AssetID in table 850) and one digital file (AssetFileID in table 850). These two fields implement relationships 852 and 854 respectively. Further, as discussed in above, there are occasions when the telecine transfer is more economically achieved by transferring several EC rolls to a single videotape. When digitized, the resulting video file is preferably kept whole. AssetInFile table 850 records the time (TimeOffset) within the file (AssetFileID in table 850) at which the specified asset (AssetID in table 850) begins.

Possibly, though uncommonly, an asset having both audio and video media components might only have one of these represented in a digital file. For instance, a dailies master tape may be digitized as a silent video file. If such is the case, it would be noted by the Picture and Sound flags in table 850.

Those skilled in the art will be familiar with the variety of options available when a telecine transfers film to video. Film is shot at 24 frames per second and NTSC video runs at 29.97 frames per second. If each frame of film is recorded in precisely a single frame of video, the timing references in the movie would correspond to a timing in the video of about 80.08% (i.e. 24/29.97). If the transfer employs the 3:2 pulldown technique, the ratio will be 100.1% (i.e. 30/29.97). Both of these assume the video is coded with non-drop timecode. If drop timecode is used, the video's timecoded is slightly modified to maintain long-term accuracy with clock time, and the ratios become 80% and 100% respectively. A simplified method for noting the timing relationship between events in an asset and the corresponding location in the asset file is to record a time scaling factor (TimeScale in table 840) for each asset file. To obtain time offset within an asset file for an event, the time of the event in the asset (described below) is added to the FileOffset (from table 850) of the asset within the asset file, and multiplied by the TimeScale (from table 840). Alternatively, other mechanisms for noting and adjusting temporal references between assets and asset files can be utilized. For example, the timebase (frames per second) and timecode mode (drop vs. non-drop) for each asset and asset file may be separately recorded in their respective tables. Algorithms for converting from one timebase to another are well know in the industry.

In steps 134 and 138, events of various types were identified and noted. Event table 870 is the place where these records are kept. Each event is uniquely identified (EventID) and associated with a specific physical asset (AssetID in table 870). The type of event is indicated (EventType), such as “SPLICE”, “SLATE”, “FLASH”, “WAVE”, or in audio assets “AUDIO SLATE”, and “CLAP”. The time or frame count at which the event occurs within the asset is also recorded (EventOffset), preferably in the asset's native timebase so as to be consistent with records generated contemporaneously with the asset (e.g. a dailies roll report).

Some events in table 870, especially those of type “SLATE” and “AUDIO SLATE” are clearly associated with scene and take information that can be recorded in Slate table 860. For a given movie (MovieID in table 860), a unique combination of scene (SceneNumber and SceneIndex), set-up (Set-Up), take (Take), camera identifier (Camera) or the alternative—camera roll (not shown), and including the re-shot, wild track, and extra take flags (Reshot, WildTrack, and ExtraTake respectively) is preferably given a unique identifier (SlateID). Alternatively, these fields can comprise a compound key to the table. An event in table 870 may be related with up to one slate in table 860 by inSlate relationship 874, implemented by SlateID in Event table 870.

Additional flags describing the nature of the slate may be included, such as a flag indicating an appearance as a tail slate (TailSlate) and a place to record notes associated with the slate (SlateNotes), such as those that may be written on the slate. Information, such as that captured in step 136, may be recorded here, or a field (not shown) for similar purposes may be kept in Event table 870.

As mentioned above, the dailies tape representing a telecine transfer of a dailies roll may be accompanied by a log in electronic form, often on a floppy disk, containing information equivalent to that otherwise gathered in steps 134, 136, and 138. Generally, these electronic logs are files output by a telecine system, non-linear editing system or other editor's tools such as the Excalibur product previously mentioned. File formats commonly used to convey these logs include FLX (Film Log EDL exchange by; da Vinci Systems, Ft. Lauterdale, Fla.), FTL (Evertz), KSL (Keyscope Log by Encore Video, Hollywood, Calif.), ATN (ATN by Aaton), ALE (AVID Log Exchange, by AVID Technology, Inc., Tewksbury, Mass.), and quite a few others. For the most part, these files can be converted from one format to the other using commercial, off-the-shelf programs such as Telecine Log Converter, by Trakker Technologies of Hermosa Beach, CA; video editing programs such as Final Cut Pro, by Apple, Inc. of Cupertino, Calif. Each of these programs can output the conversion results in ALE format, which is easily parsed and prepared for import to a database table by spreadsheet programs such as Excel, by Microsoft Corporation of Redmond, Wash. Preferably, these files can be imported into Excalibur (previously mentioned) and exported as FLX files. FLX files can be translated by the shareware program TLCFLEx.exe offered by da Vinci Systems of Hermosa Beach, Calif. into a format more readily imported by the database, using file formats that can be directly imported to popular commercial database products such as Access and SQL Server by Microsoft. File conversion and importing of such file into a database are activities well within the ordinary skill in the art.

When available, additional information, such as key numbers can be stored in a field (not shown) in Event table 870. Having key number information for events, particularly the “SPLICE” events on EC rolls, is useful for assessing the completeness of materials obtained, and potentially for overcoming errors (such as typos) entered in Event and Slate tables 870 and 860. A query can be generated which orders a movie's EC roll assets' “SLATE”events by key number. The slates related by inSlate relation 874 can be examined for missing or duplicate takes in a sequence.

Note that the nature of the relationships so described, there are only slight requirements that constrain the precedence of items being entered into the database. A studio (table 620) must precede its movies (table 630), and a movie must precede its assets (table 810) and pages (table 710). Assets must precede asset files (table 840) and events (table 870). However, pages (e.g. scripts), events, and asset files may be obtained, entered, and processed in any order, without dependence on the others. This both accommodates the manner in which these items may be relied upon to be retrieved (i.e., haphazardly), and provides the flexibility necessary to efficiently schedule and perform consolidation process 100 and the data acquisition necessary to populate the balance of the database.

However, once asset files (table 840) and events (table 870) are both available for the same asset (in table 810), a image to represent each related slate (table 860) can be generated.

Each record in Thumbnail table 880 is related to a slate in table 860 by SlateID (in table 880). Each thumbnail record (in table 880) is further related to one or more events (in table 870) by the headOf, tailOf, and syncOf relationships 884, 886, and 888 respectively, implemented by the fields InEventID, OutEventID, and SyncEventID of table 880.

The SyncEventID field is populated by the EventID of the “SLATE” event corresponding to SlateID (in table 880). This represents the event marking the clapping of the slate capture on film.

The InEventID field is populated by the first “SPLICE” or “FLASH” event occurring immediately prior to the current SyncEventID “SLATE” event. If no such event exists without an intervening “SLATE” event, then the InEventID is populated with the immediately prior “SLATE” event. This use of the prior slate event has an adverse effect of the “In” point being set far to early in the asset. Such an in-point should be flagged for manual or heuristic adjustment (e.g. if the in-point is a tail slate, accept it because it is close to the end of the prior scene; however, if it is not, estimate the in-point as about five seconds before the current slate).

This computation of the InEventID presumes that even trims of a take do not contain a splice prior to the slate, but this will not necessarily be valid if SyncEventID represents a tail slate. In the case of a tail slate appearing on an A-negative EC roll, a previous “SPLICE” event cannot be considered for the headOf relationship 884 implemented by the InEventID, unless no other “FLASH” or “SPLICE” events intervene before the previous “SLATE”. If no intervening “FLASH” event is available, then the immediately prior slate, or manual or heuristic adjustment is used, as before.

The OutEventID field is populated by the first “FLASH” or “SPLICE” event following the current SyncEventID “SLATE” event, to form the tailOf relationship 886. If no “FLASH” or “SPLICE” event occurs prior to the next “SLATE” event, then the next “SLATE” event is used instead. An adjustment similar to above is called for if the next “SLATE” event is flagged as a tail slate, since the slate will be inconveniently far off. Also, as before, on an A-negative EC roll, a “SPLICE” event cannot be considered as the end of the scene unless no other “SPLICE” or “FLASH” events precede the next “SLATE event.

Once the syncOf, headOf, and tailOf relationships 888, 84, and 886 have been created, an image can be made from a picture asset file (table 840) related through the AssetInFile table 850 to the physical asset (table 810) containing the event (table 870) associated with the SlateID (from table 880). Specifically, in order to obtain an image empirically likely to represent the take, the image is made from data about five seconds after EventOffset (in table 870) of the SyncEventID (from table 880). If SyncEventID is not available for the thumbnail, image data about fives seconds after EventOffset for InEventID (from table 880) should be used. And finally, if InEventID is not available, then image data from about five seconds before EventOffset for OutEventID (from table 880) should be selected. Recall that the EventOffset times are modified by the addition of the appropriate FileOffset time (from table 850), and multiplication by the appropriate time scale factor TimeScale (from table 840) for the asset file used. Of course, for a take having in, sync, and out events more closely spaced than five seconds, a shorter interval is used.

Once generated, the thumbnail can either be stored as a separate image file (e.g. a JPG file) with a unique name recorded in SlateImage (of table 880), or the image can exist within the database as a BLOB. If none of these criteria can be met, then the image for SlateImage cannot be generated.

If a SlateID is known to be flagged as a Wild Track (i.e. a sound track recorded without regard for the picture), then no meaningful picture image will be present. The SlateImage will preferably indicate a “Wild Track” icon.

Occasionally, a slate may begin a series, where individual takes are separated by “WAVE” events. Often, these may be safely ignored. However, if precision slate and thumbnail records are required, the following heuristic can be applied. If the associated slate is a head slate, then the segment immediately following the slate is designated as take one. The segment immediately following the first “WAVE”, “FLASH”, or “SPLICE” (in A-negative EC rolls) event is designated take two, and so on, until the next event immediately proceeds a “SLATE” event, at which point, the next slate is begun. Use this heuristic with caution, however, as series shots are frequently done in a hurry, and are tremendously informal and thus prone to errors or complete lapses in reporting.

A significantly common source of events entries are the imported telecine log files of dailies master tapes. Typically, the only kind of event listed for each scene is the “SPLICE,” which will only resolve to an InEventID and OutEventID in Thumbnail table 880. No SyncEventID will be noted. For reasons of economy, these records are generally not improved upon (i.e. nobody is assigned the task of finding and entering the “SLATE” events). This is because dailies master tapes already come with synchronized sound. The advantage provided by having the “SLATE” events for picture EC rolls primarily accrues to B-negative EC rolls as follows:

When a “SLATE” event occurs for a B-negative EC roll that shares a Slate record (table 860) with an “AUDIO SLATE” event for a sound roll or soundtrack EC roll, then it is possible for asset files of the associated picture and sound assets to be played together, in synch. This is particularly notable because after having sat in a warehouse for an arbitrary number of years, the sound and picture long ago recorded will for the first time be played in synchronism.

One such method for achieving this synchronized playback is by the construction of a Synchronized Multimedia Integration Language (SMIL, pronounced “smile”) file to relate the sound and picture assets. The SMIL file can be constructed dynamically from the database and, would look like this:

<smil xmlns=“http://www.w3.ord/2001/SMIL20.Language”>
<head>

<meta name=“title”

content=“Hey Shorty; 1995; Scene 2 Take 5” />

</head>
<body>

<par endsync=“first”>

| <video | src=“rtsp://.../HS95B001.rm” |
|---|---|
| | clipBegin=“750.88s” |
| | clipEnd=“810.61s” /> |
| <audio | src=“rtsp://.../HS95S064.rm” |

clipBegin=“735.00s”

</par>

</body>
</smil>

This particular SMIL file is associated with the hypothetical movie “Hey Shorty,” and should show sound and picture for scene two, take five, as indicated in by the title in the head of the file.

Within the body section of the SMIL file, the “par” tag in the first line indicates that the media elements called out by the video and audio tags between the <par and </par> tags are to be played in parallel.

The <video tag identifies an asset file “HS96B001.rm,” which according to the simple (but arbitrary) naming convention previously discussed, would be the first transfer tape of B-negative EC rolls. The “.rm” indicates a multimedia file of the type produced by Real Media Producer by Real Networks, Inc., of Seattle, Wash. The “rtsp://” indicates access is to be by real-time streaming protocol The portion of the B-negative transfer begins at 750.88 seconds into the asset file, and ends at the 810.61 second mark (a duration of 59.73 seconds). Preferably, the begin time is computed (as previously described) from the InEventID (from table 880), but a SyncEventID is generally usable, except in the case of a tail slate. The end time is preferably computed from the OutEventID.

Similarly, the <audio tag identifies a take from the 64th sound roll beginning at 735.00 seconds.

In this example, no end point is specified for the audio. According to the parameter specified for the <par tag (endsync=“First”), playback will conclude when either the audio runs out, or the video media has played for 59.73 seconds, whichever occurs first.

Correct playback such a SMIL file can be achieved with commercially available software such as the Real One Player, by Real Networks, Inc. of Seattle, Wash.

The keen advantage of the dynamically association between the B-negative transfer and sound roll media files is that no special processing is required prior to the request for that take to be linked. If audio were not yet available, the query of the database regarding the take in question would simply have returned a link to the a silent video segment. Similarly, if the video hadn't been available, only a reference to the soundtrack would be returned. When both happen to be available, video and audio play in synchrony.

In an alternative embodiment, a marrying process can be executed after both audio and video asset files have been indexed. The marrying process can walk through the database for a movie and find each take in a video asset file not having sound attached (e.g. those for B-negative EC roll assets), but for which an audio media asset file is available. For each such take found, the marrying process can create a new asset file with both the video and audio present, properly synchronized. The new asset file is logged in AssetFile table 840, and linked to the original picture asset via AssetInFile table 850. In still other embodiments, the marrying process may edit the existing video media file to include the audio. Additionally, numerous such married media segments may be appended into a larger file.

In still another embodiment, a result file such as the SMIL example above, but in a format appropriate to a non-linear editing system, could be directed to load the video and audio media segments, and to adjust their timing appropriately for synchronized playback.

In yet another embodiment, the marrying process could generate such non-linear editing system appropriate, take-specific files. Alternatively, the marrying process could generate a monolithic file that associates all video segments with the appropriate sound segments. Playing a particular take then becomes a matter of indexing to the right time offset in the non-linear editing file.

It is the intent of the production crew that each use of slate 400 designate a unique filmed take. The combination of a scene number, scene index (the prefix), set-up designation, take number, camera identification, and optional designation for a re-shoot or extra take should uniquely identify a section of film. However, through human error, it is not always the case.

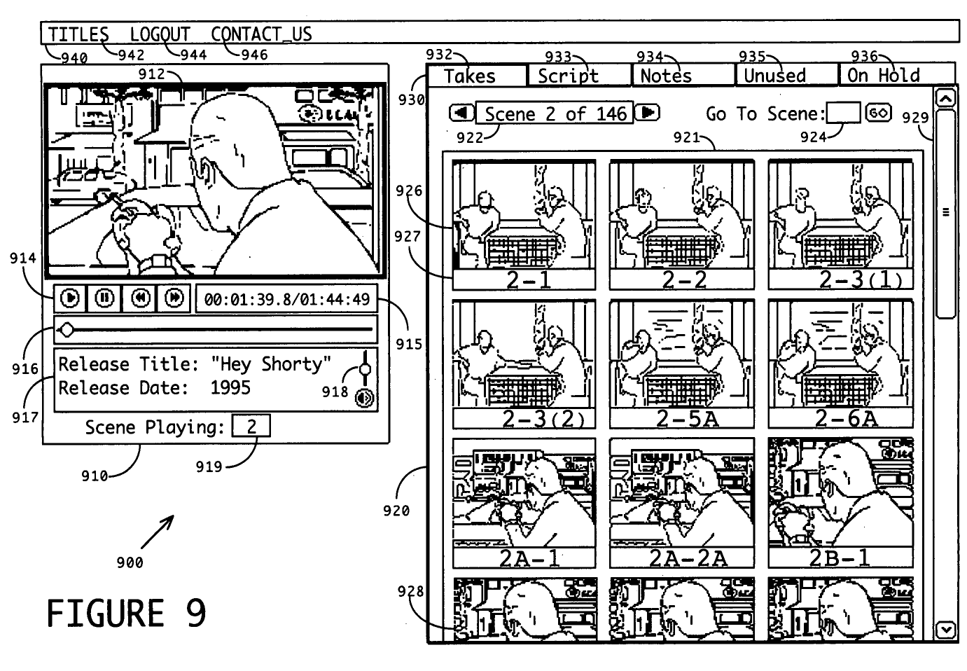

Sometimes, a production crew is rushed, or a camera assistant gets interrupted, and the take count is not incremented. Sometimes scenes are re-shot, but not identified as re-shoots. Sometimes entire scenes are rewritten and subsequently shot, but the scene index is not correctly managed. In these cases, there will exist multiple picture assets and multiple audio assets (in Asset table 810) for the same slate record (in Slate table 860) When this occurs, element consolidation process correctly associates events (in Event table 870) with the appropriate asset (in Asset table 810). However, the possibility for an error exists when trying to associate a sound asset for a slate with a picture asset for the same slate—there will be two possible parings—one right, one wrong. In such a case, the database can identify potentially bad pairings by maintaining incrementing an index each time a new thumbnail record (in Thumbnail table 880) is added for a slate. Each thumbnail record bears its index in the DuplicateCount field (in table 880). For convenience, a slate may maintain a count of duplicate assets field (not shown) in table 860. When presented (discussed in conjunction with FIG. 9) a thumbnail record preferably indicates that there is an ambiguity due to a slate duplication.

Alternatively, the database can be queried and a forensic analysis made of the duplicate slates. The operator may be able to resolve the ambiguity by editing the data (e.g., if an operator has determined that a take was mis-slated, the operator may correct the erroneous slate and thus eliminate the duplication). However, it would be preferable for a log (not shown) to be kept within the database to track such changes and to allow the prior state of the records to be referenced. This prevents the loss of valuable forensic evidence in case the operator comes to the wrong conclusion and makes a bad situation worse.

Element consolidation process 100, with respect to the handling of A-negative trims (takes where pieces of the negative are missing due to inclusion in the final edited film), relies significantly on the organization left by the editing team responsible for the original archiving of the current movie. Plausibly, some of the trim elements have been misplaced or are otherwise not integrated in a correct sequence. In such a case, a record of key numbers for each film segment integrated into each EC roll will provide sufficient ability to track the location of each piece of film. To track key numbers, they may be captured with each “SPLICE” event (certainly for each piece of-films longer than six inches) in step 134 and recorded in a key number field (not shown) in table 870. Alternatively, if the key numbers are available in machine readable form, they may be captured by a separate process (e.g. using Excalibur to scan the EC rolls for KEYKODE™ data) or the key number information may be regenerated during the telecine transfer (again, using the KEYKODE™ markings).

To assist in navigating the database, it is also desirable to identify scene boundaries in the final edited version of a movie. The asset for the edited version of the movie may be taken from any source: directly from a released DVD, or digitized from videotape (either a distributed tape or an evaluation tape made prior to release), or taken as a telecine transfer of a release print.

Preferably, the edit decision list (EDL) for the edit version is also available, as that will provide a direct lookup table allowing any time in the movie to be cross-referenced to an exact take. While this is more specific then is generally useful, it doesn't hurt.

Alternatively, someone can play the movie while following along in the script. As the movie progresses to each scene, the time at which each scene begins is noted. The detail of specific shots and takes is not usually necessary.

In some cases, a hybrid approach is appropriate. EDLs are available for some, but not all of the final negative reels of the film. Sometimes, EDLs are for another version of the film: they are correct for most of the film, but there are some points where timing shifts and required manual correction. Preferably, EDLS are used when available, corrected where inaccurate, and backfilled (as described immediately above) when missing.

The results of this scene data gathering for the edited movie are preferably stored as events and slates (in tables 870 and 860, respectively), and correctly linked to a digitized version of the edited movie. The AssetTypeName in table 820 can be “EDITED MOVIE” for the associated asset.

Alternatively, Scenes table 720 can contain a field (not shown) to indicate the time in the edited movie asset where each scene present begins. In this embodiment, the digital file of the final edited film can be noted in a field (not shown) of Movie table 630.

Further still, since movies may exist in many edit versions (e.g. original theatrical release, director's cut, edit for television, multiple foreign country versions, etc.), the database may hold an asset file for each version, as well as the scene transition events for each.

With this data about the final edited movie, the following queries are available: Given a time offset into the edited movie, return the current scene; and its opposite, given a specific scene, return the time offset in this current version of the movie where that scene begins.

A report generated from the foregoing exemplary database can indicate the physical location of physical assets and can be indexed and/or constrained by movie, scene, take, asset type, etc. Such a report represents an invaluable asset, enabling the element consolidation process to reduce the warehouse footprint of an archived movie, and yet still retain effective access to the movie's many elements.

More powerful still is a dynamic query of the database, with similar index and constraint options, but with the further addition of access to the asset images and the dynamic navigation tools provided by the edited movie data and script images. When this is provided, the element consolidation process not only reduces the footprint of an archived film in a remote warehouse, but it effectively places instant access to that archive on any studio-authorized desktop.

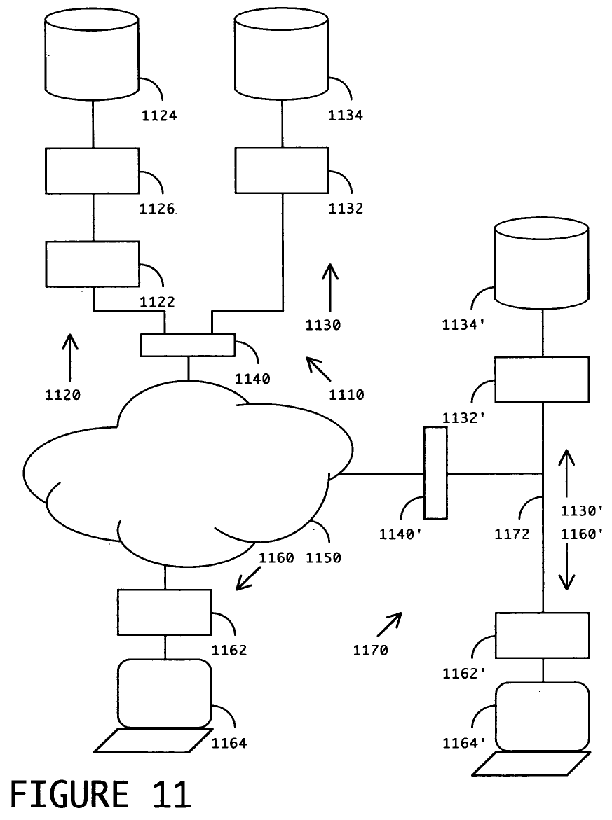

FIG. 9 shows a preferred user interface for executing dynamic queries of the database populated by the element consolidation process 100, as described above. Takes-mode navigation screen 900 features an edited movie frame 910, takes-mode assets browser window 920 in takes-mode, tab menu 930 indicating takes-mode, and main menu 940. Overall, the user interface described below can be implemented using a web browser, such as Internet Explorer by Microsoft Corporation, in conjunction with HTTP, database, and streaming media servers described in conjunction with FIG. 11. Alternatively, the user interface to the database and media could be provided as a stand-alone application accessing asset files residing on private or shared storage.

Prior to the state illustrated in FIG. 9, a user will need to have logged into the system by providing username and password. When successful, a list of available movie titles for which the user has permission is presented. Once a single movie title is selected, the user is presented with navigation screen 900.

Main menu 940 allows the user to log off of the system with logout item 944, return to the movie selection screen (not show) with titles item 942, or to contact an administrator (for example, by email or instant messaging) with contact-us item 946.

Edited movie frame 910 contains movie playback window 912, which preferably begins to play as soon as screen 900 is presented. Playback controls 914 provided pause, resume, rewind, and fast-forward functions. Time window 915 displays the current and total run times. Movie slider 916 allows rapid access to any part of the movie. Information window 917 preferably includes pertinent information about the movie. Volume control 918 allows the soundtrack to be turned up or muted. Making use of the query described above, current scene indicator 919 preferably updates as the movie in playback window 912 advances, or as controls 914 or slider 916 are manipulated. Preferably, the current scene indicator 919 can be edited by the user, to cause movie playback to jump to the specified scene.

A software module suitable for implementing edited movie frame 910 is Real One Player, by Real Networks, Inc. of Seattle, Wash. It provides a browser-embedded mode that can be configured to this application. It also provides client script access to read and write current playback time for use in executing the queries previously discussed, to generate current scene indicator 919, and to advance the movie to the specified scene.

Assets browser 920 is in takes-mode, as indicated by the graphical status of the selected takes tab 932 in tab menu 930. Unselected script tab 933, notes tab 934, unused-scenes tab 935, and takes-on-hold tab 936 are have a graphical status indicating that they are not the current selection.

When in takes-mode, assets browser window 920 provides takes thumbnail collection 921, consisting of many rows of thumbnail images for takes in the current scene. The current scene is indicated by takes scene indicator 922, and can command access to adjacent scenes with the buttons to either side. Alternatively, any desired scene is accessed by entering it into scene jump box 924.

Each individual thumbnail image 926 is accompanied by slate information 927, which preferably provides scene, scene index, set-up, take, camera, and duplication slate information from the slate record (in table 860) associated with the thumbnail image 926 that was obtained via the corresponding record in Thumbnail table 880. In the case of slate information 927, thumbnail image 926 is identified as representing scene two, take one. The thumbnail image immediately to the right is identified as scene two, take two. The third thumbnail in the first row is tentatively identified as scene two, take three, however the parenthetical duplicate index (from DuplicateCount in table 880) warns that there was an ambiguous situation, and that at least one other clip also bears the designation of scene two, take three.

Circle takes, i.e. takes other than those appearing in B-negative EC rolls, preferably have slate information (such as 927) displayed in a bold font (not illustrated). This allows a rapid, visual indication of which takes were originally considered by the director and were initially made available to the editor as dailies.

Often, a scene contains more shots and more takes than will fit on the screen at one time. Thumbnail image 928 lies partially hidden by the edge of assets browser window 920. Scroll bar 929 is used to slide the array of thumbnail images, so that thumbnail image 928, and those entirely hidden by being outside of assets browser window 920, can be accessed.

Preferably, thumbnail images such as 926 are presented in order of slate information, such as 927. While the order of presentation in assets browser window 920 is somewhat arbitrary, the following order seems quite useable.

Preferably, all takes for scenes having the same numeric value (here, “2”) are presented on a common page.

Thumbnail images for all takes for a scene having no scene index appear first, followed by those for all takes for the first scene index, etc. That is, thumbnail images for all takes of scene “2” will appear as a group before the takes for scene “A2” (if present), which will be followed by takes for scenes “B2”, etc.

Takes made during a re-shoot of a scene will follow that scene. So “R2” would come before “A2”, and “RA2” would come before “B2”.

Within a scene, thumbnails are ordered first by set-up (master shots first, then set-up “A”, then set-up “B”, etc.), followed by take, in numerical order.

If multiple cameras were used, thumbnails images for the same take are ordered by camera.

Finally, if duplicate slates exist, thumbnail images are gathered by duplicate count.

Extra takes are grouped at the bottom of their scene index group, following the thumbnails for re-shot takes.

Wild tracks can be mixed in according to the balance of their slate information, without regard to their special nature.

Clicking on any thumbnail image or slate information, such as 926 and 927 respectively, will open a pop-up media player window (not shown). Similar in function to edited movie frame 910 (though lacking indicator 919), the pop-up media player window deliver the portion of the asset files associated with the selected thumbnail image.

As an example, a user's click on slate information 927 would result in a database query starting with associated record in Thumbnail table 880 and propagating through the database relationships (as described above) to return a dynamically built SMIL file for displaying media of scene two, take one. The user interface, upon receiving the SMIL file responds by launching the pop-up media player window, which begins to play the media segments described in the SMIL file. Though described in the context of this specific embodiment, those skilled in the art will recognize a plethora of alternative implementations making use of the database to obtain playback of the appropriate take.

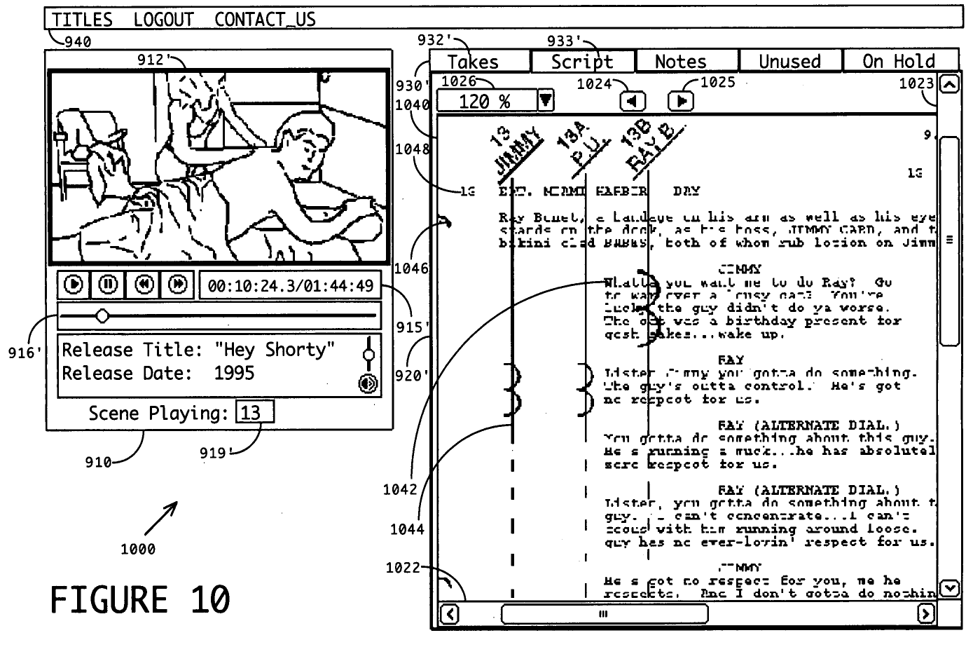

When the user clicks on scripts tab 933, the user interface switches to script-mode navigation screen 1000, shown in FIG. 10. Takes-mode tab menu 930 changes to scripts-mode tab menu 930′: The just-clicked scripts tab 933 changes graphical status to become selected scripts tab 933′, and the previously selected takes tab 932 alters its graphical status to become unselected takes tab 932′.

At the time of the switch to script-mode navigation screen 1000, the edited movie frame 910 is relatively unchanged, except the movie current playback time will have advanced, resulting in changes shown by later movie playback window 912′, updated time window 915′, later movie slider 916′, and later current scene indicator 919′.

In script-mode, asset browser window 920′, contains script page image 1040. Previous and next script page controls 1024 and 1025, respectively, allow the user to advance or turn back the script page by page. Scale control 1026 can be adjust to magnify or reduce script page image 1040. If page image 1040 exceeds the area allocated to asset browser window 920′, horizontal and vertical scroll bars 1022 and 1023, respectively, allow the hidden portions of the image to be accessed.

Preferably, script page image 1040 not only includes script text 1042, but also the script supervisor's mark-ups such as line 1044 (i.e., the lined script). Scene designations 1048 and punched hole 1046 may also be available. Further, if the script image is a color image, the color of the script page (indicating the degree of revision of the page) will also be seen.

When script-mode navigation screen 1000 is selected, the script page image first displayed is preferably the first page of the current scene playing (from current scene indicator 919′), which can be found by searching the SceneNumber and MovieID fields of Scene table 720 for the current scene number and movie respectively, and following the startsOn relationship 724 (embodied in the FirstScriptPageID) to the Page table 710 where the PageImageFile can be found.

When moving forward through the script, as with the next frame button 1025, the script page to be displayed will be found in Page table 710 by keeping MovieID and PageType consistent, but finding the next incremental PageNumber.

Note that PageNumber is merely a sequence number and does not necessarily correspond to the script writer's numbering of the script pages—typically PageNumber is one for the cover of the script and scene one usually begins when PageNumber is three; the script writer however, typically numbers the script pages with scene one beginning on page one.

If in advancing to the next page of the script the page opens on a new scene, edited movie frame 910 advances playback by selecting the first scene appearing on the script page. One method for computing the correct scene is by selecting from Scene table 720 the lowest SceneNumber for MovieID whose FirstScriptPageID relates exactly in Page table 710 to the current PageType and PageNumber. If no such scene is found, then the selection from Scene table 720 is for the highest SceneNumber for MovieID whose FirstScriptPageID relates in Page table 710 to a PageNumber less than the current PageNumber, and the current PageType.

If moving backwards to the previous page of the script by using previous page button 1024, the script page concludes a prior scene, then edited movie frame 910 jumps backwards its playback by selecting the last scene appearing on the script page. The jump in playback is needed if current SceneNumber in Scene table 720 has a FirstScriptPageID that relates to a higher PageNumber in Page 710. If so, the method for computing the new scene number is to select from Scene table 720 to highest SceneNumber for MovieID whose LastScriptPageID relates exactly in Page table 710 to the current PageType and PageNumber.

Additional script page navigation controls (e.g. jump to page, jump to scene, etc., not shown) can be provided. Additionally, much finer granularity can be provided, such as noting in the edited movie version the time location for the beginning of each script page.

Notes tab 934 will take asset browser window 920 (or 920′) to notes-mode. In notes-mode, asset browser window 920 operates in a manner similarly to script-mode asset browser window 920′, but the PageType in Page table 710 is “Script Notes” (typically, script notes are kept on the back side of the previous script page, thus the original script notes are on the leaf facing the current physical script page when laid out in a three-ring binder. When needed, additional blank pages are inserted prior to the previous script page, and additional script notes are kept on the back side of these new sheets. Because of the significant number of blank pages that end inserted into the script (said with respect to the front side of the added script notes sheets), when scanning the script, the non-blank front faces are considered “lined script” type pages, and the non-blank back sides are considered “script notes” type pages.

The unused-scenes tab 935 provides access to takes for two groups of scenes:

First is the group of those scenes not in the edited movie. If a scene 10 was shot and assets exist for according to the database, but no scene 10 takes are included in the list of scenes for the edited movie, then in unused-scenes mode, asset browser 920 (not shown in unused-scenes mode) would list “scene 10” as an unused scene. Clicking the entry for “scene 10” would switch asset browser 920 to takes-mode, with scene number 10 in current scene indicator 922. The edited movie frame cannot jump (there is no scene to jump to), but should rather pause when this happens.

Second, the scenes for any takes whose entry in Slate table 860 does not include a numeric SceneNumber component will be listed here. Sometimes, extra takes or “C-negative” (for composited effects shots) will be slated with a text scene name, rather than a scene number (e.g. “LAX nite” for takes showing planes landing at the Los Angeles airport at night.) Presumably, this is due in part to no script supervisor present to identify the shot correctly. Because these takes are not tied to the normally numbered scenes in the script, they would not be accessible by script-based navigation.

The user interface can also facilitate transactions, by allowing the user to order specific takes from the archive. If each slate information 927 was accompanied by a button (not shown), the corresponding take would be flagged as “on-hold.” When take-on-hold mode is selected, the thumbnails for the held takes would appear (much like in takes-mode asset browser 920). These could be individually approved or rejected. The kind of retrieval desired would be specified, e.g. whole EC roll, work print, inter-negative, inter-positive, videotape transfer, AVID asset file (a stand-in for editing), etc. Alternatively, the final order could be forwarded to a supervising user for approval. Ultimately the order for the held takes would be sent to the physical archive, where film handlers and technicians would provide fulfillment. In the case of an AVID asset file, the asset file (if available) could be made available for immediate transfer to the requesting user's edit bay.

Such flagging may be implemented as a simple list (not shown) of requested thumbnail records in table 880, though preferably the database is extended (not shown) to allow workflow tracking and financial tracking typical in fulfillment and e-commerce systems. Such an addition to the database to enable workflow tracking and e-commerce is well known in the art.

Edited movie frame 910 is not limited to a single version of the edited movie. In an alternative embodiment, a selector (not shown) would allow the user to choose the current version of the edited movie being used for navigation in frame 910. A notation as to which version is being used would appear on the selector (not shown) or in information window 917. When multiple versions of the edited movie are available, the unused-scenes mode of asset browser 920 (920′) would list the scenes not appearing in the currently selected version of the edited movie. Alternatively, the unused-scenes mode of asset browser could show a tabular list of all scenes unused in at least one version of the edited movie, with checkmarks in columns to indicate which specific scenes are missing from which versions. Alternatively, if the database includes fine grain information about which takes are used in each version of the edited movie, the unused scenes table could identify alternate edits of scenes that have been used in the different versions.

FIG. 11 shows a schematic architecture for the preferred embodiment to provide the functionality of the user interface described above.

Host system 1110 preferably includes an application server 1120 and a host media server 1130.

Application server 1120 is comprised of web server 1122 which performs queries on database 1124 through database server 1126. Web server 1122 is preferably a Windows NET Server, and database server 1126 is preferably SQL Server, both by Microsoft. Database 1124 is empirically about 6 megabytes per movie.

Media server 1130 is comprised of streaming server 1132 and media store 1134.

Streaming server 1132 is preferably Helix Server, by Real Networks of Seattle, Wash., on a dedicated server running either Windows Server by Microsoft, or the open source Linux operating system.

The media store 1134 is, for minimally sized streamable asset files, empirically about 70 gigabytes per movie. If editable asset files at a reasonable quality are stored, empirically another 800 gigabytes is needed, or rounding off, about one terabyte per movie—this would be doubled for DVD quality images.

Both web server 1122 and streaming server 1132 connect to the Internet 1150 via host firewall 1140.

Remote client 1160 is comprised of client computer 1162 running a web browser (not shown), and terminal 1164 (comprising the computer's I/O devices, such as monitor, keyboard, mouse). Remote client 1160 runs a web browser, such as Internet Explorer by Microsoft. Preferably the communication from the remote user to the host system 1110 is secure, for example by using the HTTPS protocol (hypertext transfer protocol with secure sockets).

Actions take by the user at remote client 1160 upon the user interface generate HTTP messages to web server 1122, which computes an appropriate response, making queries of database server 1126 as needed, and utilizing the responses to compose a reply for remote client 1160.

If a user's action at remote client 1160 requires access to streaming media, the URL for the streaming media request is routed to streaming media server 1130, where streaming server 1132 takes up the request, and begins streaming the requested asset files from media store 1134.

Some studios, however, resist their asset files being stored at a location not under their control. Further, studio IT policy may disallow their unreleased assets being transmitted via the Internet. As an alternative to a studio possessing and maintaining the entirety of a system implementing the user interface, this is offered: Studio network 1170 comprises studio media server 1130′ and studio remote client 1160′. Devices within studio network 1170 communicate over studio LAN 1172, and connect to the Internet 1150 via studio firewall 1140′. In this way, all elements of studio network 1170 are under studio IT control, and can conform to their internal policies. Further, no transfer of studio asset files over the Internet 1150 is required: the studio asset files are stored on studio media store 1134′ and distributed over the studio LAN 1172 by studio streaming server 1132′.

Studio remote client 1160′ is comprised of studio client computer 1162′ and studio terminal 1164′, which operate in the same manner as their counterparts in remote client 1160. However, when the studio remote client 1160′ is told in a response from web server 1122 that a streaming media file is needed, the URL (universal resource locator) provided by web server 1122 references studio streaming server 1132 and asset files on studio media store 1134′, rather than the host media server 1130. In this way, only studio remote clients, such as 1160′, have access to studio asset files; and those files are under the control of the studio IT management.

For this embodiment, each entry in Studio table 620 would contain the IP address (not shown) of the studio streaming server 1132′. This IP address would be provided by the studio IT management, and is generally not usable from outside the studio network 1170. If absent, the URL assigned to the host streaming server 1132 will be assumed. For example, if Studio table 620 contains an IP address for the record associated with the user at studio remote client 1160′, then that IP address would replace the ellipsis (“ . . . ”) in the audio and video tags of the example SMIL file above. The browser running on studio client computer 1162′ would parse the response (i.e., the SMIL file) and find that it is directed to access asset files through streaming server 1132′, rather than the default that the ellipsis would reference, i.e. host streaming server 1132.

Preferably, communication between the host system 1110 and the studio network 1170 is over a VPN (virtual private network) protocol provided by firewalls 1140 and 1140′.

Preferably, hierarchical path names are used for asset files on media stores 1134 and 1134′. The paths preferably separate assets first by studio (applicable only media store 1134), then by movie, and possibly asset type. Alternatively, there could be intervening layers to the hierarchy, for example, production company and/or year of release could be used to further segregate the files. Preferably, all the assets for a single movie are grouped that makes replication, backup, restoration, transfer, and archiving to off-line storage convenient.

While the preferred embodiment is discussed in the context of a web service based application, it is contemplated that other modes of implementation are entirely suitable. Further, though discussed as a database adapted to use by many studios and multiple users, a simplified implementation serving only a single studio and/or single user may be appropriate for some situations.

The particular implementations described, and the discussions regarding details, and the specifics of the figures included herein, are purely exemplary; these implementations and the examples of them, may be modified, rearranged and/or enhanced without departing from the principles of the present invention. In particular, the schema of the database is merely one of an arbitrarily large set of schemata that can satisfy the needs presented by the element consolidation process 100 and the desire to index the assets and make easily accessible the asset files.

The particular features of the user interface and the capabilities of the overall database, will depend on the architecture used to implement a system of the present invention, the operating systems of the servers and client computers selected, and the software code written both for the servers and client computers. It is not necessary to describe the details of such programming to permit a person of ordinary skill in the art to implement the application, user interface and services suitable for implementing a system within the scope of the present invention. The details of the software design and programming necessary to implement the principles of the present invention are readily understood from the description herein.

Various additional modifications to the embodiments of the invention, specifically illustrated and described herein, will be apparent to those skilled in the art, particularly in light of the teachings of this invention. Further, it will be apparent that the functionality of this invention can be incorporated into and function from within the context of other products, such as an e-commerce system. It is intended that this cover all modifications and embodiments which fall within the spirit and scope of the invention. Thus, while preferred embodiments of the present invention have been disclosed, it will be appreciated that it is not limited thereto but may be otherwise embodied within the scope of the following claims.

1. A method for consolidating a plurality of media segments from a motion picture, comprising the steps of:
(a) providing a roll, said roll having an attachment point, said attachment point having a location in said roll;
(b) selecting one of said plurality of media segments, the selected segment having a first end and a second end, said first end corresponding to a predetermined orientation;
(c) attaching said first end of the selected segment to said roll at said attachment point, thereby causing the selected segment to become a part of said roll;
(d) collecting information about the selected segment and a location in said roll corresponding to the selected segment;
(e) providing a log for recording said information and said location in said roll;
(f) recording said information and said location in association in said log;
(g) winding the selected media segment onto said roll, thereby advancing said attachment point of said roll to said second end;
(h) repeating at least steps (b), (c) and (g) for each of said plurality of media segments.
whereby said database can provide said information and the recorded location in said roll associated with any one of said plurality of media segments; and
whereby the physical volume required to store said plurality of media segments is reduced and the accessibility of said plurality of media segments is maintained.

2. The method of claim 1, wherein the selected segment consists of at least one uncut take, and steps (d) and (e) are performed at least once for the selected segment.

3. The method of claim 2, wherein said at least one uncut take consists of at least one out.

4. The method of claim 2, wherein said at least one uncut take consists of at least one B-negative take.

5. The method of claim 1,
wherein the selected segment consists of a trim of a take having a set of at least one trim, said set of at least one trim having an original order;
wherein step (b) further provides that each of said set of at least one trim is selected consecutively; and
steps (d) and (e) are performed for at least one of said set of at least one trim;
whereby each of said set of at least one trim is attached consecutively on said roll and said take is represented at least once in said log.

6. The method of claim 5,
wherein step (b) further provides that each of said set of at least one trim is selected sequentially;
whereby each of said set of at least one trim is appears on said roll according to said original order.

7. The method of claim 1, wherein said location is recorded as feet and frames measured from a mark in said roll.

8. The method of claim 1, wherein said location is recorded as timecode from measured from a mark in said roll.

9. The method of claim 1,
wherein said information includes at least one of a key number associated with the first end of the selected media segment, a splice designation, and a note labeling the selected media segment; and
said location is the attachment point;

10. The method of claim 1,
wherein said information is further about a frame in the selected media segment, and
said location indicates the frame.

11. The method of claim 10, wherein said information comprises at least one of a key number, a flash designation, and a wave designation.

12. The method of claim 10, wherein said information comprises at least one of a slate record.

13. The method of claim 12, wherein said slate record comprises a scene identifier and a take identifier.

14. The method of claim 13, wherein said slate record further comprises at least one of a camera identifier, a camera roll identifier.

15. The method of claim 1, wherein said plurality of media segments are sound media.

16. The method of claim 1, wherein said plurality of media segments are picture media.

17. The method of claim 16, further comprising the step:
(i) transferring the plurality of picture media segments to a video record; and
wherein step (d) is performed by examination of the video record.

18. The method of claim 16, further comprising the step:
(j) transferring the plurality of picture media segments to a digital record; and
wherein step (d) is performed by examination of the digital record.

19. The method of claim 1, wherein said log further associates said roll with said motion picture.

20. The method of claim 1, wherein said log comprises a database.

21. The method of claim 20, further comprising the step:
(k) producing a report from said database substantially representative of said motion picture, said roll, said plurality of media segments, said information, and said location.

22. The method of claim 1, wherein said predetermined orientation is heads-out.

23. The method of claim 1, wherein said predetermined orientation is tails-out.

24. The method of claim 1, wherein said attaching of step (c) comprises forming a permanent splice; whereby the roll is made usable in a machine-driven film transport.

25. The method of claim 1, wherein said attaching of step (c) comprises forming a temporary splice; whereby the steps of the method may be completed in substantially shorter time.

26. The method of claim 25, further comprising the steps of:
(m) unwinding said roll;
(n) replacing the temporary splice with a permanent splice; and
(o) rewinding said roll, thereby causing the predetermined orientation to be reversed;
whereby the roll is made usable in a machine-driven film transport.

27. An archive of a plurality of media segments from a motion picture comprising:
a roll formed by winding the plurality of media segments, each segment spliced to another of the segments, wherein each segment has a location within said roll and a first information; and
a database having a record for each segment associating the location of the segment within said roll, with said first information;
whereby said database provides said first information and the associated location in said roll of the plurality of media segments; and
whereby the physical volume required to store said plurality of media segments is reduced and the accessibility of said plurality of media segments is maintained.

28. The consolidated archive of claim 27, wherein the first information is comprised of at least one of a key number associated with a first end of the segment, a splice designation, and a note labeling the segment.

29. The consolidated archive of claim 27,
wherein one of the segments has a frame, said frame having a second information and a location in said roll;
said database further having a record associating the location of said frame with said second information;
whereby said database provides said second information and the location in said roll associated with the frame.

30. The consolidated archive of claim 29,
wherein said second information comprises at least one of a key number, a slate record, a flash frame designation, and a wave designation.

31. The consolidated archive of claim 29, further comprising:
a digitized media file of said plurality of file segments, said media file having a substantial correspondence to said roll;
whereby said database, from the location in said roll of said frame, identifies a portion of said media file substantially representative of said frame.

32. The consolidated archive of claim 27, further comprising:
a digitized media file of said plurality of file segments, said media file having a substantial correspondence to said roll;
whereby said database, from the location in said roll of a selected one of the plurality of media segments, identifies a portion of the media file substantially representative of the selected media segment.

33. The consolidated archive of claim 32,
wherein one of the segments has a frame, said frame having a second information and a location in said roll;
said database further having a record associating the location of said frame with said second information;
whereby said database provides said second information and the location in said roll associated with the frame; and
whereby said database, from the location in said roll of said frame, identifies a portion of said media-file substantially representative of said frame.

34. The consolidated archive of claim 33, further comprising:
a client;
a media server having access to said media file; and
a network; said network connecting said client to both said database and said media server; thereby providing said client with communication to both said database and said media server;
at least one of said database and said client further having a means for selecting from the media server a portion of the media file to be provided to the client;
said client comprising
a means for searching the database;
a means for displaying results provided by the database; and
a means for displaying the portion of the media file provided by the media server;
whereby the accessibility of said plurality of media segments is increased.

35. The consolidated archive of claim 34, wherein said media file is streaming media.

36. The consolidated archive of claim 34, wherein said media file is suitable for use by a non-linear editing station.

37. The consolidated archive of claim 34, wherein the client further comprises:
a first means for indicating to said database a portion of said roll and a format for delivery;
said database responsive to said first means, such that an order is generated to prepare said portion of said roll according to the format;
whereby a user of the client can order the media segments from the consolidated archive.
